(19) United States
(12) Patent Application Publication
(10) Pub. No.: US 2026/0181162 A1
(43) Pub. Date: Jun. 25, 2026

(54) IMAGE PROCESSING USING RESIDUAL FRAMES AND DIFFERENTIAL FRAMES

(71) Applicant: V-NOVA INTERNATIONAL LIMITED, London (GB)

(72) Inventors: Fabio MURRA, London (GB); Kevin MOCKFORD, London (GB); Stergios POULARAKIS, London (GB)

(21) Appl. No.: 19/126,388

(22) PCT Filed: Nov. 2, 2023
(86) PCT No.: PCT/GB2023/052867

§ 371 Date: May 1, 2025

(30) Foreign Application Priority Data
Nov. 2, 2022 (GB) 22386072.7

(51) Int. Cl. H04N 19/176; H04N 19/172

(52) U.S. Cl. CPC H04N 19/176; H04N 19/172

(57) ABSTRACT

A reference image (1002) and a target image (1004) are obtained. At least part of the reference image (1002) is processed to generate a processed reference image (1016). A residual frame (1020) is generated. The residual frame (1020) is indicative of differences between values of elements of the at least part of the reference image (1002) and values of corresponding elements of the processed reference image (1016). A difference frame (1024) is generated as a difference between: (i) values of elements of at least part of the target image (10004) or of an image derived based on at least part of the target image (1004); and (ii) values of elements of the at least part of the reference image (1002) or of an image derived based on the at least part of the reference image (1002). The following are output, to be encoded: (i) the residual frame (1020) or a frame derived based on the residual frame (1020); and (ii) the difference frame (1024) or a frame derived based on the difference frame (1024).

### TECHNICAL FIELD

The present disclosure relates to image processing. More particularly but not exclusively, the present disclosure relates to image processing measures (such as methods, apparatuses, systems, computer programs and bit streams) that use residual frames and differential frames.

### BACKGROUND

Compression and decompression of signals is a consideration in many known systems. Many types of signal, for example video, audio or volumetric signals, may be compressed and encoded for transmission, for example over a data communications network. When such a signal is decoded, it may be desired to increase a level of quality of the signal and/or recover as much of the information contained in the original signal as possible.

Some known systems exploit scalable encoding techniques. Scalable encoding involves encoding a signal along with information to allow the reconstruction of the signal at one or more different levels of quality, for example depending on the capabilities of the decoder and the available bandwidth.

There are several considerations relating to the reconstruction of signals in a scalable encoding system. One such consideration is the amount of information that is stored, used and/or transmitted. The amount of information may vary, for example depending on the desired level of quality of the reconstructed signal, the nature of the information that is used in the reconstruction, and/or how such information is configured. Another consideration is the ability of the decoder to reconstruct the signal accurately and/or reliably and/or efficiently.

In the context of extended reality (XR), left-eye and right-eye views of a scene may be encoded, transmitted, and decoded together as a single image. XR includes augmented reality (AR) and/or virtual reality (VR). Differences between values (e.g. pixel values) of elements (e.g. pixels) in one such image and values of corresponding elements in a subsequent such concatenated image in a video sequence may be signalled, rather than absolute values. This can exploit temporal similarities between different XR images in a video sequence.

### SUMMARY

Various aspects of the present disclosure are set out in the appended claims.

Further features and advantages will become apparent from the following description of preferred embodiments, given by way of example only, which is made with reference to the accompanying drawings.

### BRIEF DESCRIPTION OF THE DRAWINGS

FIG. 1 shows a schematic block diagram of an example of a signal processing system;

FIGS. 2A and 2B show a schematic block diagram of another example of a signal processing system;

FIG. 3 shows a schematic block diagram of an example disparity compensation prediction (DCP) system;

FIG. 4 shows a schematic representation of an object in a scene;

FIG. 5 shows a schematic block diagram of an example of an image processing system;

FIG. 6 shows a schematic representation depicting an example of differential image processing;

FIG. 7 shows a schematic representation depicting another example of differential image processing;

FIG. 8 shows a schematic representation depicting another example of differential image processing;

FIG. 9 shows a schematic representation depicting another example of differential image processing;

FIG. 10 shows a schematic block diagram of another example image processing system;

FIG. 11 shows a schematic block diagram of another example image processing system;

FIG. 12 shows a schematic block diagram of another example image processing system;

FIG. 13 shows a schematic block diagram of another example image processing system;

FIG. 14 shows a schematic representation of an example scene;

FIG. 15 shows a schematic representation of an example scene and an example of how images representing the scene may be processed;

FIG. 16 shows a schematic representation of an example scene and an example difference frame;

FIG. 17 shows a schematic representation of temporal processing in relation to difference frames;

FIG. 18 shows a schematic representation of multiple images and an example of how those images may be processed;

FIG. 19 shows a schematic block diagram of another example image processing system; and

FIG. 20 shows a schematic block diagram of an example of an apparatus.

### DETAILED DESCRIPTION

In general terms, and not by way of limitation, examples described herein send only one of a left-eye view and a right-eye view of a scene to a receiving device, rather than sending both the left-eye view and the right-eye view. Examples additionally send a difference frame that converts the left-eye view or the right-eye view (whichever is sent) to the other of the left-eye view and the right-eye view.

As an alternative to sending the difference frame, a shift value could be sent which would shift all pixels in, say, the left-eye view by a small number of pixels (for example, one or two pixels) to generate, say, the right-eye view. In principle, this could account for the different perspectives of the left-eye view and the right-eye view. However, in such examples, residual frame encoding effectiveness (which will be described in more detail below) may be reduced. This is because shifting the entire set of pixels of the left-eye view by the same amount may not, in practice, result in an accurate representation of the corresponding right-eye view. A different type of transformation, other than a horizontal pixel shift, could be applied to one view. For example, the transformation may comprise horizontal and vertical components. If the vertical component is zero, the transformation is a horizontal shift only.

By using the difference frame, examples described herein maintain residual frame encoding effectiveness, while still enabling, say, the left-eye view to be readily and efficiently converted to the right-eye view.

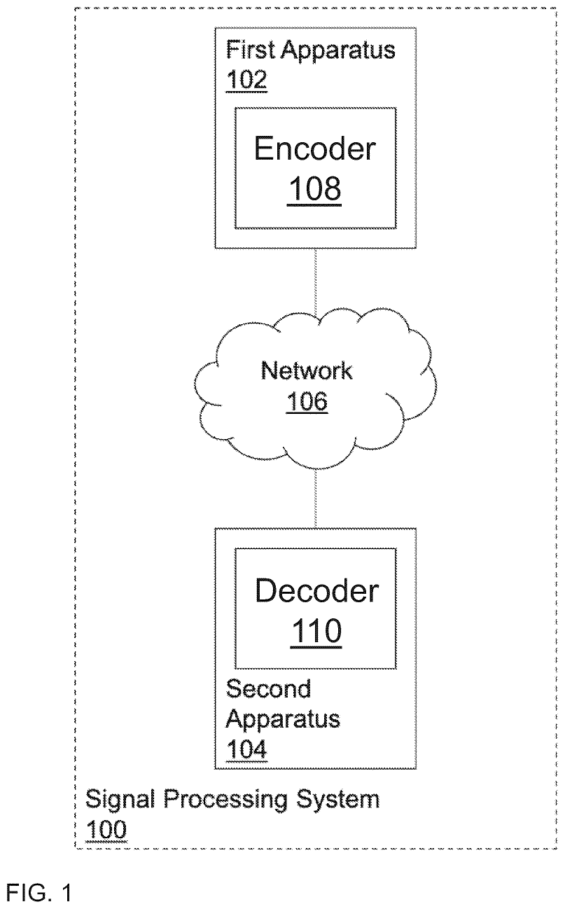

Referring to FIG. 1, there is shown an example of a signal processing system 100. The signal processing system 100 is used to process signals. Examples of types of signal include, but are not limited to, video signals, image signals, audio signals, volumetric signals such as those used in medical, scientific or holographic imaging, or other multidimensional signals.

The signal processing system 100 includes a first apparatus 102 and a second apparatus 104. The first apparatus 102 and second apparatus 104 may have a client-server relationship, with the first apparatus 102 performing the functions of a server device and the second apparatus 104 performing the functions of a client device. The signal processing system 100 may include at least one additional apparatus (not shown). The first apparatus 102 and/or second apparatus 104 may comprise one or more components. The one or more components may be implemented in hardware and/or software. The one or more components may be co-located or may be located remotely from each other in the signal processing system 100. Examples of types of apparatus include, but are not limited to, computerised devices, handheld or laptop computers, tablets, mobile devices, games consoles, smart televisions, set-top boxes, XR headsets (including AR and/or VR headsets) etc.

The first apparatus 102 is communicatively coupled to the second apparatus 104 via a data communications network 106. Examples of the data communications network 106 include, but are not limited to, the Internet, a Local Area Network (LAN) and a Wide Area Network (WAN). The first and/or second apparatus 102, 104 may have a wired and/or wireless connection to the data communications network 106.

In this example, the first apparatus 102 comprises an encoder 108. The encoder 108 is configured to encode data comprised in and/or derived based on the signal, which is referred to hereinafter as “signal data”. For example, where the signal is a video signal, the encoder 108 is configured to encode video data. Video data comprises a sequence of multiple images or frames. The encoder 108 may perform one or more further functions in addition to encoding signal data. The encoder 108 may be embodied in various different ways. For example, the encoder 108 may be embodied in hardware and/or software. The encoder 108 may encode metadata associated with the signal. The first apparatus 102 may use one or more than one encoder 108.

Although in this example the first apparatus 102 comprises the encoder 108, in other examples the first apparatus 102 is separate from the encoder 108. In such examples, the first apparatus 102 is communicatively coupled to the encoder 108. The first apparatus 102 may be embodied as one or more software functions and/or hardware modules.

In this example, the second apparatus 104 comprises a decoder 110. The decoder 110 is configured to decode signal data. The decoder 110 may perform one or more further functions in addition to decoding signal data. The decoder 110 may be embodied in various different ways. For example, the decoder 110 may be embodied in hardware and/or software. The decoder 110 may decoder metadata associated with the signal. The second apparatus 104 may use one or more than one decoder 110.

Although in this example the second apparatus 104 comprises the decoder 110, in other examples, the second apparatus 104 is separate from the decoder 110. In such examples, the second apparatus 104 is communicatively coupled to the decoder 110. The second apparatus 104 may be embodied as one or more software functions and/or hardware modules.

The encoder 108 encodes signal data and transmits the encoded signal data to the decoder 110 via the data communications network 106. The decoder 110 decodes the received, encoded signal data and generates decoded signal data. The decoder 110 may output the decoded signal data, or data derived using the decoded signal data. For example, the decoder 110 may output such data for display on one or more display devices associated with the second apparatus 104.

In some examples described herein, the encoder 108 transmits to the decoder 110 a representation of a signal at a given level of quality and information the decoder 110 can use to reconstruct a representation of the signal at one or more higher levels of quality. Such information may be referred to as “reconstruction data”. In some examples, “reconstruction” of a representation involves obtaining a representation that is not an exact replica of an original representation. The extent to which the representation is the same as the original representation may depend on various factors including, but not limited to, quantisation levels. A representation of a signal at a given level of quality may be considered to be a rendition, version or depiction of data comprised in the signal at the given level of quality. In some examples, the reconstruction data is included in the signal data that is encoded by the encoder 108 and transmitted to the decoder 110. For example, the reconstruction data may be in the form of metadata. In some examples, the reconstruction data is encoded and transmitted separately from the signal data.

The information the decoder 110 uses to reconstruct the representation of the signal at the one or more higher levels of quality may comprise residual data, as described in more detail below. Residual data is an example of reconstruction data. The information the decoder 110 uses to reconstruct the representation of the signal at the one or more higher levels of quality may also comprise configuration data relating to processing of the residual data. The configuration data may indicate how the residual data has been processed by the encoder 108 and/or how the residual data is to be processed by the decoder 110. The configuration data may be signaled to the decoder 110, for example in the form of metadata.

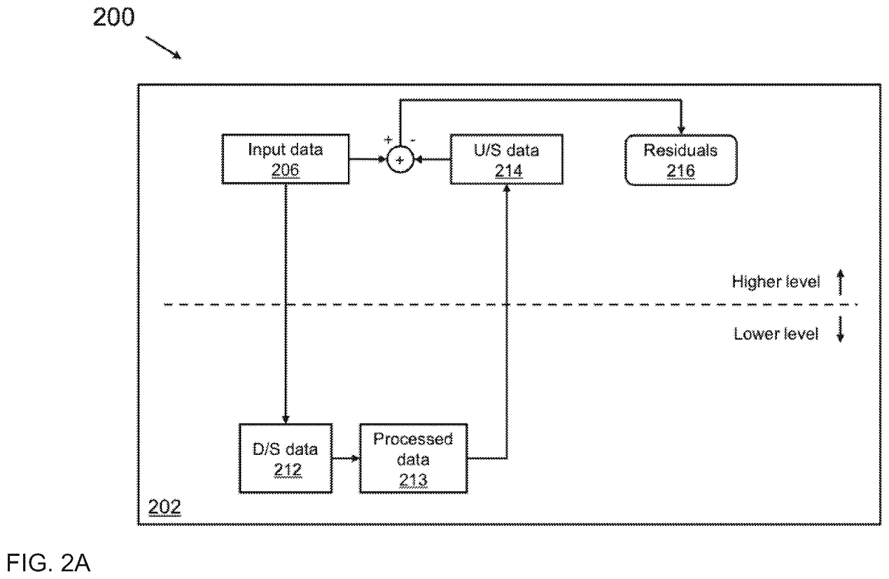

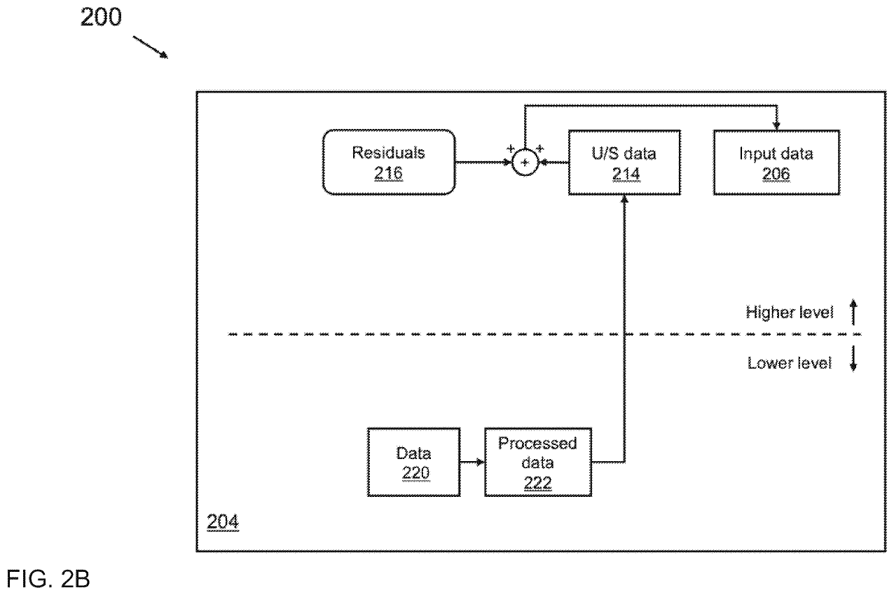

Referring to FIGS. 2A and 2B, there is shown schematically an example of a signal processing system 200. The signal processing system 200 includes a first apparatus 202 and a second apparatus 204. In this example, the first apparatus 202 comprises an encoder and the second apparatus 204 comprises a decoder. However, as explained above, in other examples, the encoder is not comprised in the first apparatus 202 and/or the decoder is not comprised in the second apparatus 204. In each of the first apparatus 202 and the second apparatus 204, items are shown on two logical levels. The two levels are separated by a dashed line. Items on the first, highest level relate to data at a first level of quality. Items on the second, lowest level relate to data at a second level of quality. The first level of quality is higher than the second level of quality. The first and second levels of quality relate to a tiered hierarchy having multiple levels of quality. In some examples, the tiered hierarchy comprises more than two levels of quality. In such examples, the first apparatus 202 and the second apparatus 204 may include more than two different levels. There may be one or more other levels above and/or below those depicted in FIGS. 2A and 2B. As described herein, in certain cases, the levels of quality may correspond to different spatial resolutions.

Referring first to FIG. 2A, the first apparatus 202 obtains a first representation of an image at the first level of quality 206. A representation of a given image is a representation of data comprised in the image. The image may be a given frame of a video. The first representation of the image at the first level of quality 206 will be referred to as “input data” hereinafter as, in this example, it is data provided as an input to the encoder in the first apparatus 202. The first apparatus 202 may receive the input data 206. For example, the first apparatus 202 may receive the input data 206 from at least one other apparatus. The first apparatus 202 may be configured to receive successive portions of input data 206, e.g. successive frames of a video, and to perform the operations described herein to each successive frame. For example, a video may comprise frames F₁, F₂, . . . F_{T} and the first apparatus 202 may process each of these in turn.

The first apparatus 202 derives data 212 based on the input data 206. In this example, the data 212 based on the input data 206 is a representation 212 of the image at the second, lower level of quality. In this example, the data 212 is derived by performing a downsampling operation on the input data 206 and will therefore be referred to as “downsampled data” hereinafter. In other examples, the data 212 is derived by performing an operation other than a downsampling operation on the input data 206, or the data 212 is the same as the input data 206 (i.e. the input data 206 is not processed, e.g. downsampled).

In this example, the downsampled data 212 is processed to generate processed data 213 at the second level of quality. In other examples, the downsampled data 212 is not processed at the second level of quality. As such, the first apparatus 202 may generate data at the second level of quality, where the data at the second level of quality comprises the downsampled data 212 or the processed data 213.

In some examples, generating the processed data 213 involves the downsampled data 212 being encoded. Such encoding may occur within the first apparatus 202, or the first apparatus 202 may output the processed data 213 to an external encoder. Encoding the downsampled data 212 produces an encoded image at the second level of quality. The first apparatus 202 may output the encoded image, for example for transmission to the second apparatus 204. A series of encoded images, e.g. forming an encoded video, as output for transmission to the second apparatus 204 may be referred to as a “base” stream. As explained above, instead of being produced in the first apparatus 202, the encoded image may be produced by an encoder that is separate from the first apparatus 202. The encoded image may be part of an H.264 encoded video, or otherwise. Generating the processed data 213 may, for example, comprise generating successive frames of video as output by a separate encoder such as an H.264 video encoder. An intermediate set of data for the generation of the processed data 213 may comprise the output of such an encoder, as opposed to any intermediate data generated by the separate encoder.

Generating the processed data 213 at the second level of quality may further involve decoding the encoded image at the second level of quality. The decoding operation may be performed to emulate a decoding operation at the second apparatus 204, as will become apparent below. Decoding the encoded image produces a decoded image at the second level of quality. In some examples, the first apparatus 202 decodes the encoded image at the second level of quality to produce the decoded image at the second level of quality. In other examples, the first apparatus 202 receives the decoded image at the second level of quality, for example from an encoder and/or decoder that is separate from the first apparatus 202. The encoded image may be decoded using an H.264 decoder. The decoding by a separate decoder may comprise inputting encoded video, such as an encoded data stream configured for transmission to a remote decoder, into a separate black-box decoder implemented together with the first apparatus 202 to generate successive decoded frames of video. Processed data 213 may thus comprise a frame of video data that is generated via a complex non-linear encoding and decoding process, where the encoding and decoding process may involve modelling spatio-temporal correlations as per a particular encoding standard such as H.264. However, because the output of any encoder is fed into a corresponding decoder, this complexity is effectively hidden from the first apparatus 202.

In an example, generating the processed data 213 at the second level of quality further involves obtaining correction data based on a comparison between the downsampled data 212 and the decoded image obtained by the first apparatus 202, for example based on the difference between the downsampled data 212 and the decoded image. The correction data can be used to correct for errors introduced in encoding and decoding the downsampled data 212. In some examples, the first apparatus 202 outputs the correction data, for example for transmission to the second apparatus 204, as well as the encoded signal. This allows the recipient to correct for the errors introduced in encoding and decoding the downsampled data 212. This correction data may also be referred to as a “first enhancement” stream. As the correction data may be based on the difference between the downsampled data 212 and the decoded image it may be seen as a form of residual data (e.g. that is different from the other set of residual data described later below).

In some examples, generating the processed data 213 at the second level of quality further involves correcting the decoded image using the correction data. For example, the correction data as output for transmission may be placed into a form suitable for combination with the decoded image, and then added to the decoded image. This may be performed on a frame-by-frame basis. In other examples, rather than correcting the decoded image using the correction data, the first apparatus 202 uses the downsampled data 212. For example, in certain cases, just the encoded then decoded data may be used and in other cases, encoding and decoding may be replaced by other processing.

In some examples, generating the processed data 213 involves performing one or more operations other than the encoding, decoding, obtaining and correcting acts described above.

The first apparatus 202 obtains data 214 based on the data at the second level of quality. As indicated above, the data at the second level of quality may comprise the processed data 213, or the downsampled data 212 where the downsampled data 212 is not processed at the lower level. As described above, in certain cases, the processed data 213 may comprise a reconstructed video stream (e.g. from an encoding-decoding operation) that is corrected using correction data. In the example of FIGS. 2A and 2B, the data 214 is a second representation of the image at the first level of quality, the first representation of the image at the first level of quality being the input data 206. The second representation at the first level of quality may be considered to be a preliminary or predicted representation of the image at the first level of quality. In this example, the first apparatus 202 derives the data 214 by performing an upsampling operation on the data at the second level of quality. The data 214 will be referred to hereinafter as “upsampled data”. However, in other examples one or more other operations could be used to derive the data 214, for example where data 212 is not derived by downsampling the input data 206.

The input data 206 and the upsampled data 214 are used to obtain residual data 216. The residual data 216 is associated with the image. The residual data 216 may be in the form of a set of residual elements, which may be referred to as a “residual frame” or a “residual image”. A residual element in the set of residual elements 216 may be associated with a respective image element in the input data 206. An example of an image element is a pixel.

In this example, a given residual element is obtained by subtracting a value of an image element in the upsampled data 214 from a value of a corresponding image element in the input data 206. As such, the residual data 216 is useable in combination with the upsampled data 214 to reconstruct the input data 206. The residual data 216 may also be referred to as “reconstruction data” or “enhancement data”. In one case, the residual data 216 may form part of a “second enhancement” stream.

The first apparatus 202 obtains configuration data relating to processing of the residual data 216. The configuration data indicates how the residual data 216 has been processed and/or generated by the first apparatus 202 and/or how the residual data 216 is to be processed by the second apparatus 204. The configuration data may comprise a set of configuration parameters. The configuration data may be useable to control how the second apparatus 204 processes data and/or reconstructs the input data 206 using the residual data 216. The configuration data may relate to one or more characteristics of the residual data 216. The configuration data may relate to one or more characteristics of the input data 206. Different configuration data may result in different processing being performed on and/or using the residual data 216. The configuration data is therefore useable to reconstruct the input data 206 using the residual data 216. As described below, in certain cases, configuration data may also relate to the correction data described herein.

In this example, the first apparatus 202 transmits to the second apparatus 204 data based on the downsampled data 212, data based on the residual data 216, and the configuration data, to enable the second apparatus 204 to reconstruct the input data 206. Turning now to FIG. 2B, the second apparatus 204 receives data 220 based on (e.g. derived from) the downsampled data 212. The second apparatus 204 also receives data based on the residual data 216. For example, the second apparatus 204 may receive a “base” stream (data 220), a “first enhancement stream” (any correction data) and a “second enhancement stream” (residual data 216). The second apparatus 204 also receives the configuration data relating to processing of the residual data 216. The data 220 based on the downsampled data 212 may be the downsampled data 212 itself, the processed data 213, or data derived from the downsampled data 212 or the processed data 213. The data based on the residual data 216 may be the residual data 216 itself, or data derived from the residual data 216.

In some examples, the received data 220 comprises the processed data 213, which may comprise the encoded image at the second level of quality and/or the correction data. In some examples, for example where the first apparatus 202 has processed the downsampled data 212 to generate the processed data 213, the second apparatus 204 processes the received data 220 to generate processed data 222. Such processing by the second apparatus 204 may comprise decoding an encoded image (e.g. that forms part of a “base” encoded video stream) to produce a decoded image at the second level of quality. In some examples, the processing by the second apparatus 204 comprises correcting the decoded image using obtained correction data. Hence, the processed data 222 may comprise a frame of corrected data at the second level of quality. In some examples, the encoded image at the second level of quality is decoded by a decoder that is separate from the second apparatus 204. The encoded image at the second level of quality may be decoded using an H.264 decoder.

In other examples, the received data 220 comprises the downsampled data 212 and does not comprise the processed data 213. In some such examples, the second apparatus 204 does not process the received data 220 to generate processed data 222.

The second apparatus 204 uses data at the second level of quality to derive the upsampled data 214. As indicated above, the data at the second level of quality may comprise the processed data 222, or the received data 220 where the second apparatus 204 does not process the received data 220 at the second level of quality. The upsampled data 214 is a preliminary representation of the image at the first level of quality. The upsampled data 214 may be derived by performing an upsampling operation on the data at the second level of quality.

The second apparatus 204 obtains the residual data 216. The residual data 216 is useable with the upsampled data 214 to reconstruct the input data 206. The residual data 216 is indicative of a comparison between the input data 206 and the upsampled data 214.

The second apparatus 204 also obtains the configuration data related to processing of the residual data 216. The configuration data is useable by the second apparatus 204 to reconstruct the input data 206. For example, the configuration data may indicate a characteristic or property relating to the residual data 216 that affects how the residual data 216 is to be used and/or processed, or whether the residual data 216 is to be used at all. In some examples, the configuration data comprises the residual data 216.

There are several considerations relating to such processing. One such consideration is the amount of information that is generated, stored, transmitted and/or processed. The more information that is used, the greater the amount of resources that may be involved in handling such information. Examples of such resources include transmission resources, storage resources and processing resources. Some signal processing techniques allow a relatively small amount of information to be used. This may reduce the amount of data transmitted via the data communications network 106. The savings may be particularly relevant where the data relates to high quality video data, where the amount of information transmitted can be especially high.

Other considerations include the ability of the decoder to perform image reconstruction accurately, reliably, and/or efficiently. Performing image reconstruction accurately and reliably may affect the ultimate visual quality of the displayed image and consequently may affect a viewer's engagement with the image and/or with a video comprising the image. This can be especially relevant to XR. Efficient reconstruction is especially effective for mobile computing devices, which may readily be used in XR applications.

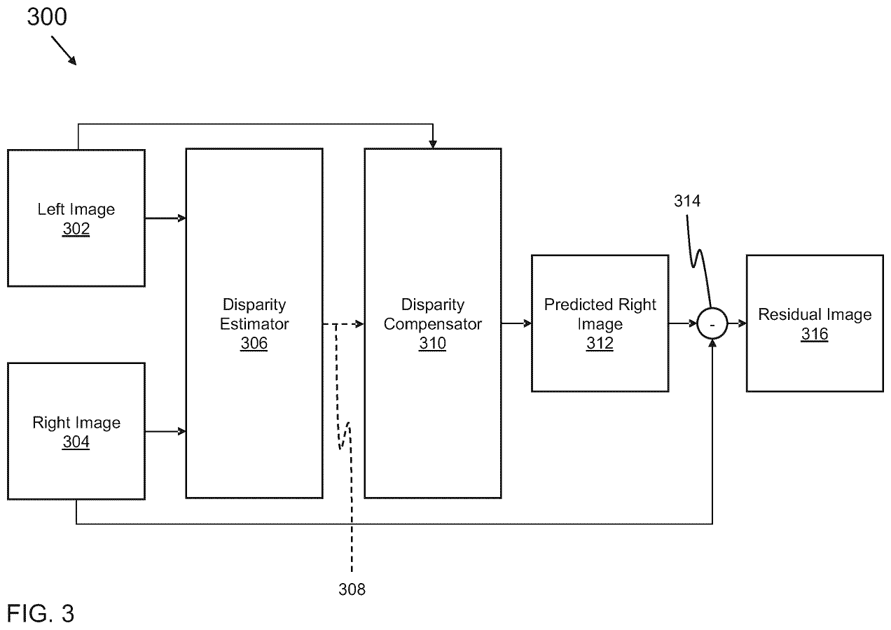

Referring to FIG. 3, there is shown an example of a disparity compensation prediction (DCP) system 300.

DCP is described in references such as “Deep Stereo Image Compression via Bi-directional Coding” (Jianjun Lei et al.), “Vector Lifting Schemes for Stereo Image Coding” (Mounir Kaaniche et al.), and “Dense Disparity Estimation in Multiview Video Coding” (I. Daribo et al.).

The DCP system 300 receives left and right images 302, 304. The left image 302 corresponds to a left-eye view of a scene and the right image 304 corresponds to a right-eye view of the scene.

The left and right images 302, 304 may exhibit a large amount of inter-view redundancy. In other words, there may be a large amount of shared content between the left-eye and right-eye views.

Instead of transmitting both the left and right images 302, 304 to a receiving device, the inter-view redundancies can be exploited by employing DCP stereo image compression.

In accordance with DCP, the left and right images 302, 304 are input to a disparity estimator 306. The disparity estimator 306 estimates disparity between the left and right images 302, 304. The output of the disparity estimator 306 is a disparity estimate 308, which is indicated in FIG. 3 using a broken line.

The left image 302 and the disparity estimate 308 are input to a disparity compensator 310. The disparity compensator 310 compensates the left image 302 using the disparity estimate 308 and outputs a predicted right image 312.

The predicted right image 312 is compared to the (actual) right image 304. Here, a comparator 314 subtracts one of the right image 304 and the predicted right image 312 from the other of the right image 304 and the predicted right image 312. References to subtracting one image from another may be understood to mean subtracting a value of an element (for example, a pixel) of one image from a value of a corresponding element (for example, a pixel) of the other image. The elements may be corresponding in that they are located in the same positions (e.g., x-y coordinates) in each of the images, or otherwise. However, the elements may be corresponding in another sense. For example, corresponding elements may be elements that represent the same content as each other in multiple images even if they are not located in the same positions in each of the images.

As such, DCP does not compare the left and right images 302, 304, but compares different versions of the same image; namely, the right image 304 in this example.

The result of the comparison is a residual image 316.

The left image 302, the disparity estimate 308 and/or the residual image 316 may be encoded and are transmitted to a receiving device.

The receiving device obtains, potentially after decoding, the (decoded) left image 302, the (decoded) disparity estimate 308, and the (decoded) residual image 316. The receiving device provides the (decoded) left image 302 and the (decoded) disparity estimate 308 to a disparity compensator 310 that corresponds to the disparity compensator 310, and the disparity compensator 310 outputs a predicted right image 312 that corresponds to the predicted right image 312. The receiving device then combines the predicted right image 312 with the (decoded) residual image 316 to obtain a right image 304 corresponding to the right image 304. Such combining may comprise adding the predicted right image 312 and the (decoded) residual image 316 together.

As such, DCP can reduce the amount of data transmitted between the transmitting and receiving devices compared to transmitting both the left and right images 302, 304. DCP can therefore provide efficient compression of the left and right images 302, 304. However, DCP can involve significant processing time, processing resources and/or processing complexity, especially, but not exclusively, at the receiving device. Additionally, DCP requires specific and dedicated DCP functionality, such as the disparity estimator 306 and the disparity compensator 310. DCP might also not leverage existing standards and/or protocols in terms of image compression and/or communication between the transmitter and receiver devices. While image processing attributes such as high latency, high processing resource requirements and/or high processing complexity may be tolerable in some scenarios, for example where highly efficient compression is most important, they may be less tolerable in other scenarios. For example, in the context of XR, latency can significantly negatively impact user experience. Additionally, some types of receiving device have limited resources, such as hardware resources, for complex processing. For example, some mobile computing devices such as, but not limited to, smartphones, tablet computing devices and XR headsets, may have limited processing capabilities, data storage, battery capacity and so on compared to other types of computing device. In such other scenarios, the compression efficiency of DCP may not outweigh the associated processing time, resource and/or complexity trade-offs.

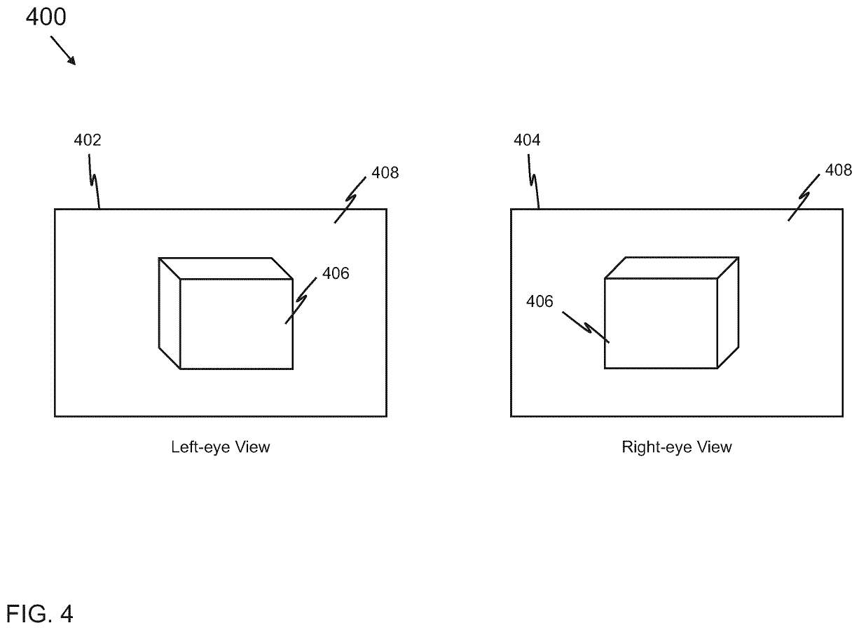

Referring to FIG. 4, there is shown an example of a representation 400 of an object in a scene.

In this example, the representation 400 comprises left-eye and right-eye views 402, 404. The left-eye and right-eye views 402, 404 may have been obtained in various different ways. For example, the left-eye and right-eye views 402, 404 may have been captured by one or more cameras, may be computer-generated, and so on.

In this example, the scene comprises an object 406 which, in this example, is a box. Different scenes may comprise different types and/or numbers of objects.

The left-eye view 402 shows, in an exaggerated manner for ease of understanding, a view of the box 406 as would be seen by a left eye of a viewer. The right-eye view 402 shows, again in an exaggerated manner for ease of understanding, a view of the box 406 as would be seen by a right eye of a viewer.

Although the left-eye and right-eye views 402, 404 are different views of a scene, there is a significant amount of shared visual content between the left-eye and right-eye views 402, 404. For example, the background content 408 may be the same or very similar, content on the front and top of the box 406 may be the same or very similar, and the main difference may be in the content of the left and right sides of the box 406. Again, it is emphasised that the difference between the left-eye and right-eye views 402, 404 has been exaggerated for ease of understanding.

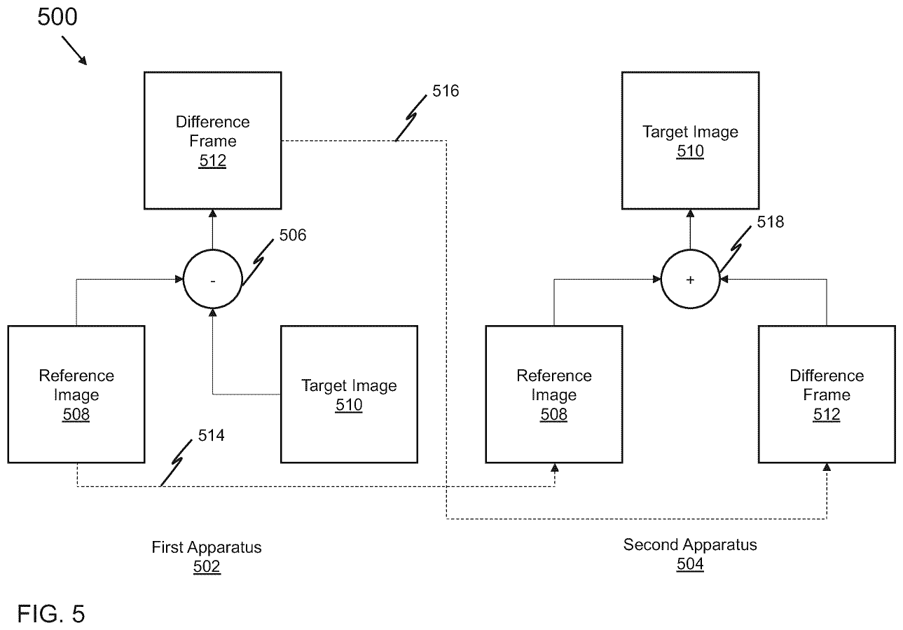

Referring to FIG. 5, there is shown an example of an image processing system 500.

The example image processing system 500 may be used to process images differentially, as will become more apparent from the description below. In this example, such processing is performed by a first apparatus 502 and by a second apparatus 504.

In this example, a comparator 506 compares the differences between a reference image 508 and a target image 510. In examples described herein, the reference image 508 generally corresponds to one of a left-eye view and a right-eye view of a scene and the target image 510 generally corresponds to the other of the left-eye view and the right-eye view of the scene. Other examples of reference and target images 508, 510 will, however, be described.

In some examples, an image corresponds to a video frame. In such examples, the image is one of a sequence of images (or frames) that make up a video. However, an image may not correspond to a video frame in other examples. For example, the image may be a still image in the form of a photograph of a scene.

In this example, the comparator 506 outputs a difference frame 512. In this example, the difference frame 512 is based on the differences between the reference image 508 and the target image 510. The difference frame 512 is referred to as a “frame” rather than an “image” to emphasise that the difference frame 512 may not appear, if displayed to a human viewer, as an “image” in the same manner that the reference and target images 508, 510 would. However, the terms may be used interchangeably herein. For example, the difference frame 512 may be referred to as a “difference image”. The reference image 508 may be referred to as a reference frame and/or the target image 510 may be referred to as a target frame for similar reasons. In this specific example, the difference frame 512 represents differences between the left-eye view of the scene and the right-eye view of the scene, as represented by the reference and target images 508, 510 respectively.

The difference frame 512 in effect converts the reference image 508 into the target image 510, or vice versa. For example, the difference frame 512 may be based on the difference between, for each element in the reference image 508 and the target image 510, a value of an element of the reference image 508 and a value of a corresponding element of the target image 510. The difference frame 512 may comprise those difference values. This may be represented mathematically as dᵢⱼ=rᵢⱼ−tᵢⱼ, where dᵢⱼ represents the element in the iₜₕ row and jₜₕ column of the difference frame 512, rᵢⱼ represents the element in the iₜₕ row and jₜₕ column of the reference image 508, and tᵢⱼ represents the element in the iₜₕ row and jₜₕ column of the target image 510. In other examples, the difference frame 512 may be based on the differences between values of elements of the reference image 508 and values of corresponding elements of the target image 510, while not comprising those difference values themselves. For example, the difference frame 512 may comprise quantised versions of those difference values. This may be represented mathematically as dᵢⱼ=f(rᵢⱼ−tᵢⱼ), where f represents some function, operation or other processing performed on the difference values. The frame resulting from such processing may still be referred to as a “difference” frame accordingly.

In this example, the first apparatus 502 outputs the reference image 508 (and/or data based on reference image 508) and the difference frame 512 (and/or data based on difference frame 512) to the second apparatus 504 as shown by items 514 and 516 respectively in FIG. 5.

Specifically, in examples, the reference image 508 and/or the difference frame 512 may be processed prior to being output to the second apparatus 504. Such processing may include, but is not limited to, transforming, quantising and/or encoding. Such processing may be performed by the first apparatus 502, or the first apparatus 502 may output the reference image 508 and/or the difference frame 512 to an external entity to be processed. In the case of encoding, the first apparatus 502 may perform encoding itself and/or may output data to an external encoder. The first apparatus 502 may receive encoded data from the external encoder and/or the external encoder may output the encoded data to an entity other than the first apparatus 502, such as the second apparatus 504.

The second apparatus 504 obtains the reference image 508 and the difference frame 512. As explained above, the second apparatus 504 may receive data based on reference image 508 and/or data based on the difference frame 512 and may process such data to obtain the reference image 508 and/or the difference frame 512. Such processing may comprise decoding such data and/or outputting such data to an external decoder and receiving a decoded version of such data from the external decoder.

In this example, the reference image 508 and the difference frame 512 are provided as inputs to a combiner 518. The combiner 518 combines the reference image 508 and the difference frame 512 and outputs the target image 510.

The second apparatus 504 may output the reference and target images 508, 510. For example, the reference and target images 508, 510 may be output for display on a display device.

The example system 500 shown in FIG. 5 differs from that shown in FIG. 3 in various ways.

For example, the DCP system 300 uses three elements not shown in FIG. 5, namely an estimator 306, a compensator 310 and a predicted image 312. The system 500 shown in FIG. 5 is, thus, less complex than the DCP system 300. This can result in lower latency and lower processing resource usage, both for the first apparatus 502 and the second apparatus 504. Depending, for example, on the content of the reference and target images 508, 510, the difference frame 512 may be larger (in terms of data size) than the combination of the disparity estimate 308 and residual image 316 of the DCP system 300, and therefore may not compress as efficiently as the combination of the disparity estimate 308 and residual image 316 of the DCP system 300. However, as explained above, in some scenarios the lower compression efficiency can be tolerated, for example where the latency and processing resource gains are more relevant.

The term “differential processing” will be used herein to mean processing of a reference image and a target image that results in a difference frame, where the reference image and the target image are both intended to be displayed together and viewed together by a viewer. Differential processing thus differs from other types of processing that involve differences being calculated based on reference and target images, but where one or both of the reference and target images is not intended to be displayed and viewed by a viewer. An example of such other type of processing (i.e. non-differential processing) is where residuals are calculated based on an upsampled image and a source image and where the residuals are applied to the upsampled image to generate a reconstructed version of the source image. In such non-differential processing, the upsampled image is not intended to be displayed with the reconstructed version of the source image, and indeed is not intended to be displayed at all.

In some examples, the reference image 508 and/or the target image 510 is generated as a result of transcoding or rendering point cloud or mesh data. Point cloud data and mesh data may be large (in terms of data size). Specifically, some examples comprise generating the reference image 508 and/or the target image 510 by transcoding or rendering point cloud or mesh data. However, such data can provide increased flexibility in the context of XR. For example, such data (rather than a transcoded or rendered version of such data) may be provided to an entity close to a display device (in a network sense). Such an entity can then generate a transcoded or rendered version of such data with information such as gaze of the viewer late in the processing pipeline. As such, the transcoding or rendering may be considered to be a pre-processing action. Such a pre-processing action may be performed in accordance with any example described herein.

As such, image processing measures (such as methods, systems, apparatuses, computer programs, bit streams, etc.) are provided herein. A reference image 508 is obtained. The reference image 508 represents one of a left-eye view of a scene and a right-eye view of the scene. A target image 510 is obtained. The target image 510 represents the other of the left-eye view of the scene and the right-eye view of the scene. A difference frame 512 is generated by subtracting values of elements of all or part of one of the reference image 508 and the target image 510 from values of corresponding elements of all or part of the other of the reference image 508 and the target image 510. The generated difference frame 512 is output 516 to be encoded by an encoder.

Such examples provide low complexity compared to the above-described DCP processing. This can provide reduced latency and/or power consumption at a receiving device. This may, however, trade off compression efficiency. Such examples may also leverage existing standards more readily than DCP processing.

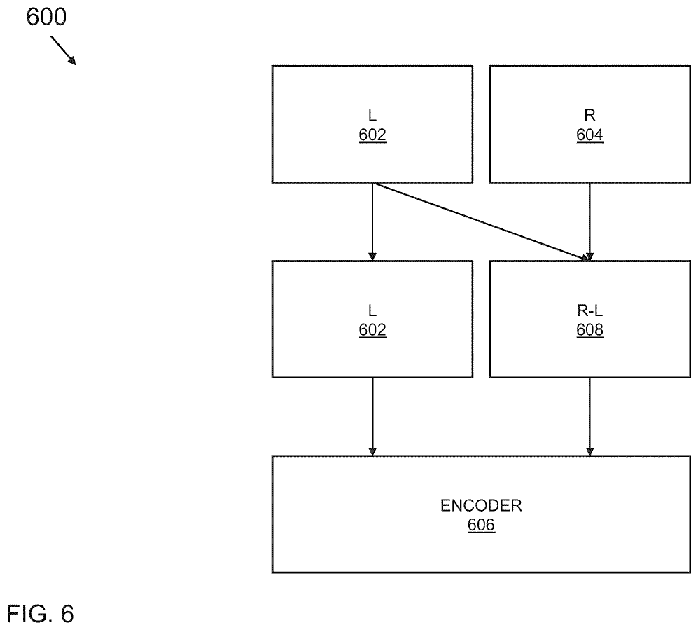

Referring to FIG. 6, there is shown a representation 600 depicting an example of differential image processing.

In this example, reference and target images 602, 604 are obtained. In this specific example, the reference and target images 602, 604 are left-eye and right-eye views of a scene respectively, and are denoted “L” and “R” respectively in FIG. 6.

In this example, the reference image 602 and/or data based on the reference image 602 is output to an encoder 606. As such, although, for ease of explanation, FIG. 6 shows the reference image 602 being output to the encoder 606, the reference image 602 may be processed before being output to the encoder 606. For example, the reference image 602 may be downsampled before being output to the encoder 606.

In this example, a difference frame 608, denoted “R-L” in FIG. 6, is generated. In this example, the difference frame 608 is generated by subtracting the reference image 602 from the target image 604. However, in other examples, the difference frame 608 may be generated by subtracting the target image 604 from the reference image 602, which may be denoted “L-R”. In this example, the difference frame 608 is output to the encoder 606.

The encoder 606 may encode the reference image 602 and the difference frame 608 together or separately.

References to the reference image 602 and the difference frame 608 being “output” to a decoder should be understood to encompass the decoder being internal to or external to an entity that obtains reference and target images 602, 604 and that generates the difference frame 608.

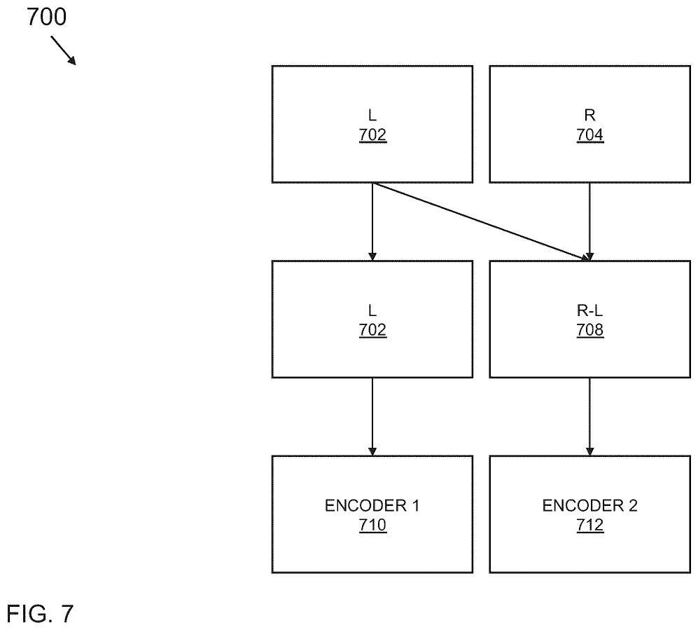

Referring to FIG. 7, there is shown a representation 700 depicting another example of differential image processing.

This example shares elements with the representation 600 described above with reference to FIG. 6.

However, in this example, the reference image 702 is provided to a first encoder 710 and the difference frame 708 is provided to a second encoder 712.

The first and second encoder 710, 712 may be the same type of encoder as each other. For example, the first and second encoder 710, 712 may use the same codec as each other. Alternatively, the first encoder 710 may be a first type of encoder and the second encoder 712 may be a second, different type of encoder. For example, the first encoder 710 may be selected and/or optimised based on one or more characteristics of the reference image 702. The second encoder 712 may be selected and/or optimised based on one or more characteristics of the difference frame 708.

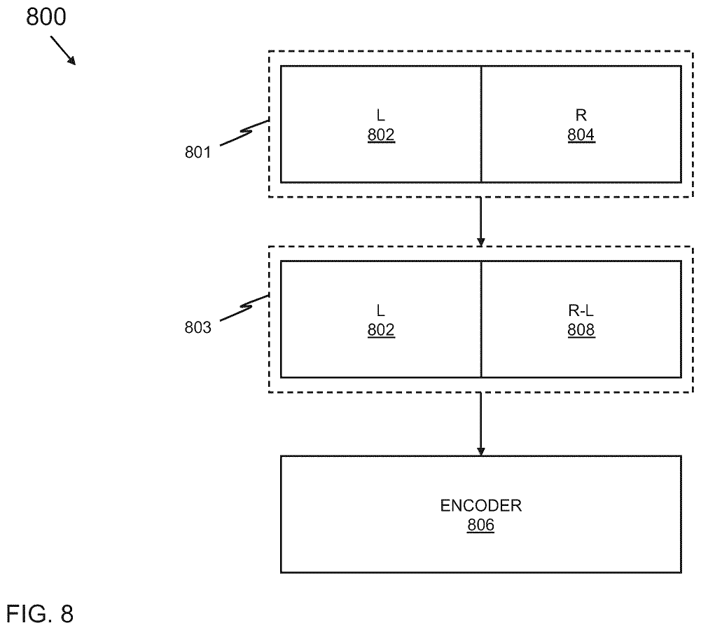

Referring to FIG. 8, there is shown a representation 800 depicting another example of differential image processing.

In this example, there is a first image 801. The first image 801 comprises the reference and target images 802, 804. The first image 801 is referred to herein as a “concatenated” image because the reference and target images 802, 804 are concatenated together in the first image 801. It should be appreciated that the first image 801 may have been obtained by concatenating the reference and target images 802, 804 together, or that the first image 801 may have been generated with the reference and target images 802, 804 already (concatenated) together. The reference and target images 802, 804 may be adjacent to each other in the first image 801. Alternatively, the reference and target images 802, 804 may be separated from each other in the first image 801, for example by a visual divider line, while still being concatenated. The first image 801 may be referred to as a “combined” image where the reference and target images 802, 804 are combined together in the first image 801.

In this example, there is also a second image 803. The second image 801 comprises the reference image 802 and a difference frame 808. The difference frame 808 is based on differences between the reference image 802 and the target frame 804. The second image 803 may also be referred to as a concatenated image, for corresponding reasons to those for the first image 801.

The second image 803, which in this example is a concatenated image, is provided to the decoder 806.

As such, image processing measures (such as methods, systems, apparatuses, computer programs, bit streams, etc.) are provided herein. A first concatenated image 801 is obtained. The first concatenated image 801 comprises (i) a reference image region comprising the reference image 802 and (ii) a target image region comprising the target image 804. A second concatenated image 803 is generated based on the obtained first concatenated image 801. The second concatenated image 803 comprises (i) a reference image region comprising the reference image 802 and (ii) a difference frame region comprising the difference frame 808. The difference frame 808 is indicative of differences between values of elements of the reference image 802 and values of corresponding elements of the target image 804. The difference frame 808 may comprise the differences between values of elements of the reference image 802 and values of corresponding elements of the target image 804 and/or may comprise other data indicative of the same. The second concatenated image 803 is output to be encoded by the encoder 806.

In this example, the first and second concatenated images 801, 803 have the same spatial resolution as each other. In this example, the spatial resolution corresponds to width and height. However, in other examples, the first and second concatenated images 801, 803 have different spatial resolutions from each other. For example, the spatial resolutions may differ by one or more pixels in one or both of width and height.

In this example, the reference and target images 802, 804 represent different views of the same scene. In particular, in this example, the reference and target images 802, 804 represent left-eye and right-eye views respectively of a scene.

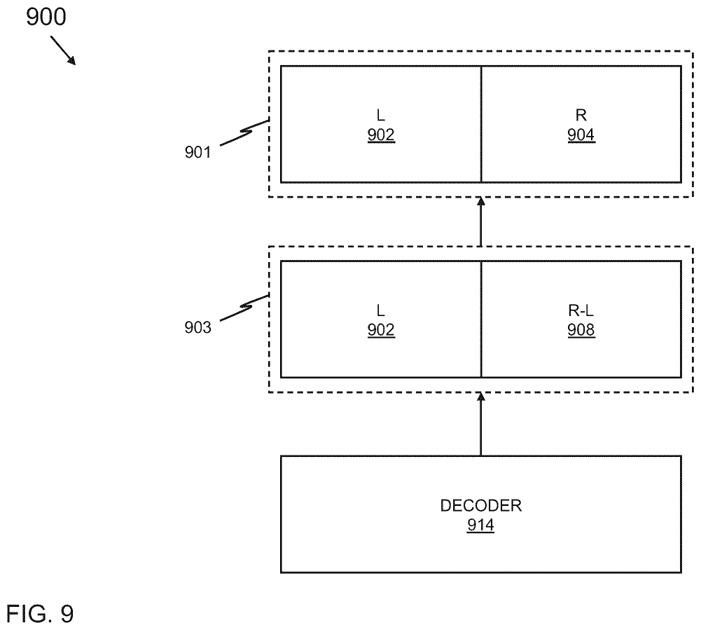

Referring to FIG. 9, there is shown a representation 900 depicting another example of differential image processing.

The processing shown in FIG. 9 in effect reverses the processing shown in FIG. 8.

For example, a decoder 914 obtains the (encoded) output of the encoder 806 and decodes the same to generate a first concatenated image 903. The first concatenated image 903 comprises the reference image 902 (and/or the data based on the reference image 902) and the difference frame 908 (and/or the data based on the difference frame 908). A second concatenated image 901 can be obtained by processing the first concatenated image 903. For example, the reference image 902 may be extracted from the first concatenated image 903 or, where the first concatenated image 903 comprises data based on the reference image 902, such data may be processed to obtain the reference image 902. Such processing may involve upsampling. The reference frame 904 may be obtained by combining the reference image 902 (and/or the data based on the reference image 902) and the difference frame 908 (and/or the data based on the difference frame 908). Where the first concatenated image 903 comprises data based on the reference image 902, rather than the reference image 902 itself, such data may be processed prior to being combined with the difference frame 908 (and/or the data based on the difference frame 908). Such processing may involve upsampling.

As such, image processing measures (such as methods, systems, apparatuses, computer programs, bit streams, etc.) are provided herein. A first concatenated image 903 is obtained. The first concatenated image 903 comprises (i) a reference image region comprising the reference image 902 and (ii) a difference frame region comprising the difference frame 908. The difference frame 908 is indicative of differences between values of elements of the reference image 902 and values of corresponding elements of the target image 904. A second concatenated image 901 is generated based on the obtained first concatenated image 903. The second concatenated image 901 comprises (i) a reference image region comprising the reference image 902 and (ii) a target image region comprising the target image 904.

As such, image processing measures (such as methods, systems, apparatuses, computer programs, bit streams, etc.) are provided herein. A decoded reference image 902 and a decoded difference frame 908 are obtained from a decoder 914. The decoded reference image 902 and the decoded difference frame 908 are decoded versions of an encoded reference image 902 and an encoded difference frame 908 respectively. A target image 904 is generated based on the decoded reference image 902 and the decoded difference frame 908. The reference image 902 and the target image 904 are output to be displayed together.

In this example, the reference image 902 and the target image 904 are not necessarily comprised in a concatenated image. While the reference image 902 and the target image 904 are not necessarily comprised in a concatenated image in all examples, having a concatenated image is especially effective where the reference image 902 and the target image 904 are to be displayed together.

In some examples, the reference image 902 and the target image 904 being displayed together comprises the reference image 902 and the target image 904 being displayed together temporally. The term “together temporally” is used herein to mean at the same time as each other, from the perspective and perception of a viewer. For example, multiple images may be displayed together without being displayed at exactly the same time as each other when any timing differences are imperceptible to the viewer.

In some examples, the reference image 902 and the target image 904 being displayed together comprises the reference image 902 and the target image 904 being displayed on the same display device as each other. The term “display device” is used herein to mean equipment on which one or more images can be displayed. A display device may comprise one or more than one screen. As such, in this example, one viewer can view both the reference image 902 and the target image 904 on the same display device.

In some examples, the display device comprises a XR display device. As explained above, examples described herein are especially effective in the context of XR. This is, in particular, in relation to reducing latency and having regard to limited receiving device hardware resources.

In some examples described herein, an encoder comprises a Low Complexity Enhancement Video Coding, LCEVC, encoder and/or a decoder comprises an LCEVC decoder. The reader is referred to US patent application no. U.S. Ser. No. 17/122,434 (published as US 2021/0211752), International patent application no. PCT/GB2020/050695 (published as WO 2020/188273), UK Patent application no. GB 2210438.4, UK patent application no. GB 2205618.8, International patent application no. PCT/GB2022/052406, International patent application no. PCT/GB2021/052685 (published as WO 2022/079450), US patent application no. U.S. Ser. No. 17/372,052 (published as US 2022/0086456), International patent application no. PCT/GB2021/050335 (published as WO 2021/161028), US patent application no. U.S. Ser. No. 17/173,941 (published as US 2021/0168389), International patent application no. PCT/GB2017/052142 (published as WO 2018/015764), and International patent application no. PCT/GB2018/053552 (published as WO2019/111010), all of which are incorporated by reference herein. An LCEVC encoder and/or decoder may encode and/or decode residual frames especially effectively. In some examples, one or more types of encoder encodes and/or decoder decodes residual frames, and one or more other types of encoder encodes and/or decoder decodes difference frames.

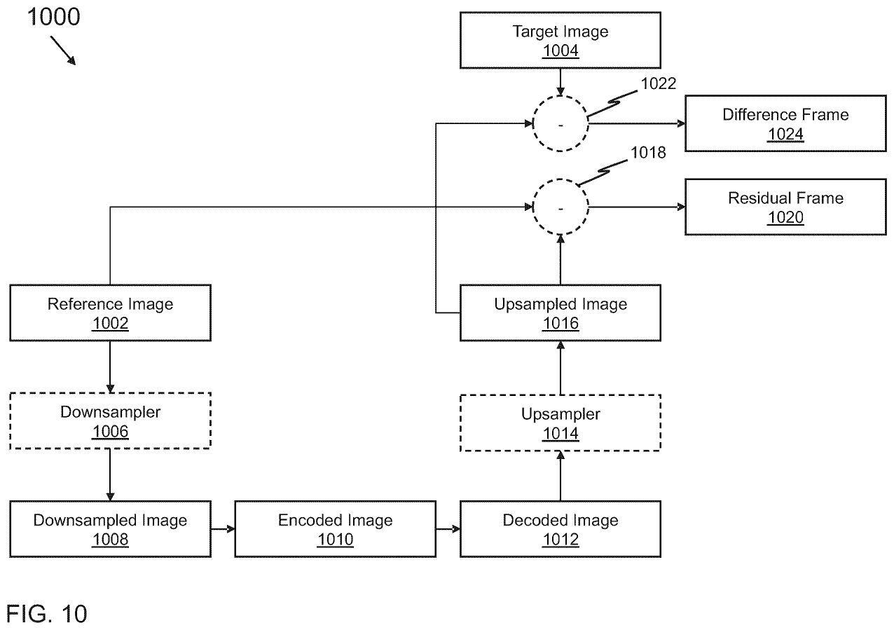

Referring to FIG. 10, there is shown another example image processing system 1000. To facilitate understanding, data elements are shown in solid lines and data processing elements are shown in broken lines in FIG. 10.

In this example, the image processing system 1000 obtains a reference image 1002 and a target image 1004.

In this example, a downsampler 1006 downsamples the reference image 1002 to generate a downsampled image 1008. However, as explained above, in other examples the reference image 1002 is not downsampled or is processed in a different manner.

In this example, an encoded image 1010 obtained. The downsampled image 1008 may be output to an external encoder which returns the encoded image 1010 and/or the downsampled image 1008 may be output to an encoder within the system 1000 to generate the encoded image 1010.

In this example, a decoded image 1012 is obtained. The decoded image 1012 is a decoded version of the encoded image 1010. The encoded image 1010 may be output to an external decoder which returns the decoded image 1012 and/or the encoded image 1010 may output to a decoder within the system 1000 to generate the decoded image 1012.

In this example, an upsampler 1014 upsamples the decoded image 1012 to generate an upsampled image 1016. However, as explained above, in other examples the decoded image 1012 is not upsampled or is processed in a different manner.

In this example, a comparator 1018 compares the reference image 1002 and the upsampled image 1016 to each other and outputs a residual frame 1020. The residual frame 1020 may be processed before being output. Such processing may comprise, but is not limited to comprising, transformation, quantisation and/or encoding.

In this example, another comparator 1022 compares the target image 1004 and the upsampled image 1016 and outputs a difference frame 1024. The target image 1004 and/or the upsampled image 1016 may be processed before being input to the comparator 1022. Such processing may comprise, but is not limited to comprising, transformation. The difference frame 1024 may be processed before being output. Such processing may comprise, but is not limited to comprising, transformation, quantisation and/or encoding.

Where the residual frame 1020 and the difference frame 1024 are processed before being output, the residual frame 1020 and the difference frame 1024 may be processed differently. For example, one may be subject to transformation and the other may not be subject to transformation, each may be subject to different types of transformation, etc.

In this example, the system 1000 also outputs the reference image 1002. The reference image 1002 may be processed before being output. Such processing may comprise, but is not limited to comprising, encoding.

Again, any processing of the reference image 1002 may be different to any processing of the residual frame 1020 and/or the difference frame 1024. Such differences in processing may reflect and/or take account of the different properties of the reference image 1002, the residual frame 1020 and the difference frame 1024.

As such, image processing measures (such as methods, systems, apparatuses, computer programs, bit streams, etc.) are provided herein. Such measures may be for processing XR images. XR images are images that can be used for XR applications.

A reference image 1002 and a target image 1004 are obtained. The term “obtained” is used in relation to the reference image 1002 and the target image 1004 to encompass receiving from outside the system 1000, receiving from within the system 1000, and generating within the system 1000.

At least part of the reference image 1002 is processed to generate a processed reference image. The term “at least part” is used herein to encompass all or a portion. As such, all of the reference image 1002 may be processed, or a portion may be processed. A portion may also be referred to as a “region” or a “part”. In this specific example, the processed reference image corresponds to the upsampled image 1016. However, the processed reference image may be another image in other examples, as will be described in more detail below.

A residual frame 1020 is generated. The residual frame 1020 is indicative of differences between values of elements of the at least part of the reference image 1002 and values of corresponding elements of the processed reference image, which in this example corresponds to the upsampled image 1016. The residual frame 1020 may be indicative of the differences in that the residual frame 1020 may comprise the differences themselves and/or may comprise another indication of the differences. For example, the differences may be quantised, the residual frame 1020 may comprise the quantized differences, and the quantized differences may be indicative of the differences (albeit not the differences themselves).

A difference frame 1024 is generated as a difference between (i) values of elements of at least part of the target image 1004 or of an image derived based on at least part of the target image 1004 and (ii) values of elements of the at least part of the reference image 1002 or of an image derived based on the at least part of the reference image 1002. The image derived based on at least part of the target image 1004 may correspond to a processed version of the target image 1004. The processed version of the target image 1004 may comprise a quantised and/or transformed and/or smoothed version of the target image 1004. Such processing may subsequently be reversed, for example by a receiving device. The image derived based on the at least part of the reference image 1002 may correspond to the upsampled image 1016.

Various data may be output, for example to one or more encoders. As above, the term “output” is used in this context to encompass both (i) outputting from an entity inside the system 1000 to another entity inside of the system 1000 and (ii) outputting from an entity within the system 1000 to an entity outside the system 1000.

The residual frame 1020 or a frame derived based on the residual frame 1020 is output to be encoded by an encoder. The frame derived based on the residual frame 1020 may be a processed (e.g. transformed and/or quantised) version of the residual frame 1020.

The difference frame 1024 or a frame derived based on the difference frame 1024 is output to be encoded by an encoder, which may be the same as or different from the residual frame encoder. The frame derived based on the difference frame 1024 may be a processed (e.g. transformed and/or quantised) version of the difference frame 1024.

In examples, the reference image 1002 and/or data derived based on the reference image is output to be encoded. Such encoding may be by the same encoder as an encoder that encodes the residual frame 1020 and/or the difference frame 1024 or may be by a different encoder.

The processing of the at least part of the reference image 1002 may comprise: (i) outputting, to be encoded to generate an encoded image 1010, the at least part of the reference image 1002 or the image derived based on the at least part of the reference image 1002; and (ii) obtaining a decoded image 1012 from a decoder, the decoded image 1012 being a decoded version of the encoded image 1010. The image derived based on the at least part of the reference image 1002 may correspond to the downsampled image 1008.

The term “obtained” is used in relation to the decoded image 1012 to encompass both (i) receiving the decoded image 1012 from a decoder inside the system 1000 and (ii) receiving the decoded image 1012 from a decoder outside the system 1000.

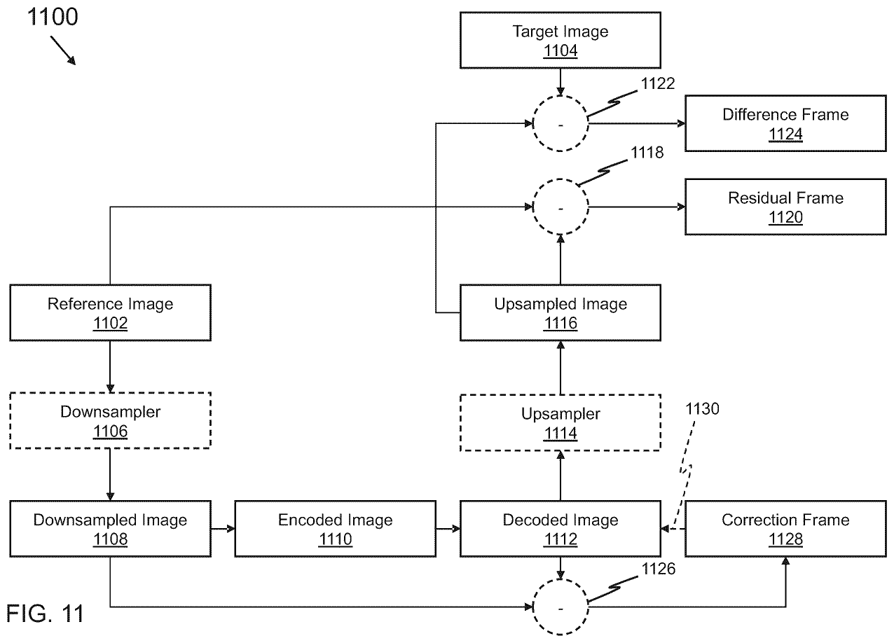

The processing of the at least part of the reference image 1002 may comprise: (i) downsampling the at least part of the reference image 1002 using a downsampler 1006 to generate a downsampled image 1008; (ii) outputting, to be encoded to generate an encoded image 1010, the downsampled image 1008; (iii) obtaining a decoded image 1012 from a decoder, the decoded image 1012 being a decoded version of the encoded image 1010; and (iv) upsampling the decoded image 1012 or an image based on the decoded image 1012 using an upsampler 1014 to generate the processed reference image, which in this example corresponds to the upsampled image 1016. The image based on the decoded image 1012 may be a corrected version of the decoded image 1012, as will be described below with reference to FIG. 11, or otherwise.

In this example, the difference frame 1024 is generated based on differences between values of elements of (at least part of) the target image 1004 and values of corresponding elements of the processed reference image, namely the upsampled image 1016.

Referring to FIG. 11, there is shown another example image processing system 1100.

The example image processing system 1100 is similar to the example image processing system 1000 described above with reference to FIG. 10. However, the example image processing system 1100 comprises a correction subsystem.

In particular, the example image processing system 1100 comprises another comparator 1126. The comparator 1126 compares the downsampled image 1108 with the decoded image 1112 and outputs a correction frame 1128. The correction frame 1128 may be processed before being output. Such processing may comprise, but is not limited to comprising, transformation, quantisation and/or encoding.

The correction frame 1128 in effect corrects for encoder-decoder errors introduced in generating the encoded image 1110 and the decoded image 1112.

The correction frame 1128 may be applied to the decoded image 1112 as represented by broken arrow 1130. The decoded image 1112 with the correction frame 1128 applied, may be provided to the upsampler 1114, instead of the decoded image 1112 with that correction being provided to the upsampler 1114. The correction frame 1128 may be applied to the decoded image 1112 by adding the correction frame 1128 and the decoded image 1112 together, or otherwise.

Alternatively or additionally, the downsampled image 1108 may be provided to the upsampler 1114, since the correction frame 1128 should undo any encoder-decoder errors and, thus, correct the decoded image 1112 to be closer to, or even the same as, the downsampled image 1108.

Although, for convenience and brevity, the correction subsystem is not shown and/or described in connection with each example system and method described herein, the correction subsystem may nevertheless be used in such systems and methods.

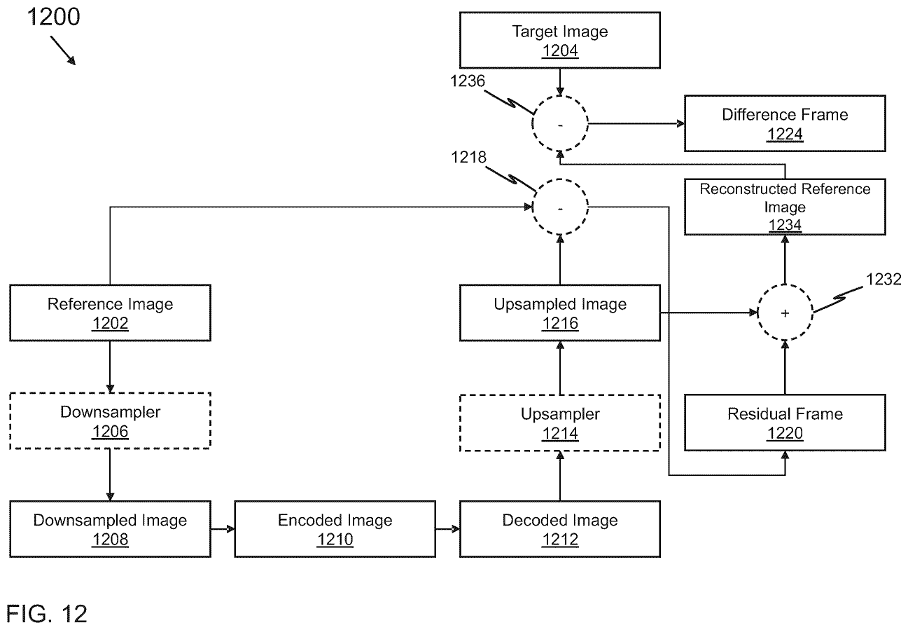

Referring to FIG. 12, there is shown another example image processing system 1200.

The example image processing system 1200 is similar to the example image processing system 1000 described above with reference to FIG. 10.

However, in this example, the residual frame 1220 output by the comparator 1218 is provided to a combiner 1232. The combiner 1232 outputs a reconstructed reference image 1234. The reconstructed reference image 1234 is a reconstructed version of the reference image 1202 which applies the residual frame 1220 to the upsampled image 1216. The residual frame 1220 in effect is intended to undo any upsampler-downsampler errors and/or asymmetries.

Additionally, a comparator 1236 compares the target image 1204 and the reconstructed reference image 1234 and outputs the difference frame 1224. The comparator 1236 may correspond to the comparators 1022 and 1122 in that the comparator 1236 outputs the difference frame. However, since the inputs are different, different reference sign suffixes are used.

As such, in the example image processing systems 1000, 1100 described above with reference to FIGS. 10 and 11 respectively, the difference frame 1024, 1124 is the difference between the target image 1004, 1104 and the upsampled image 1016, 1116. However, in the example image processing systems 1100, the difference frame 1124 is based on a residual-enhanced version of the upsampled image 1216, namely the reconstructed reference image 1234. Since the reconstructed reference image 1234 should be more similar than the upsampled image 1216 to the reference image 1202, the difference frame 1224 should have smaller values than the difference frames 1024, 1124 based on the upsampled images 1016, 1116. The difference frame 1224 should therefore be smaller (in terms of data size) and/or more efficient to process (for example encode) than the difference frames 1024, 1124.

Since a receiving device would receive the residual frame 1220 (and/or data based on the residual frame 1220) and would use the residual frame 1220 to reconstruct the reconstructed reference image 1234, the receiving device does not receive additional data in connection with use of the image processing system 1200 compared to the image processing systems 1000, 1100.

Although, for convenience and brevity, the use of the reconstructed reference image 1234 for generating the difference frame 1224 (in place of the upsampled image 1216) is not shown and/or described in connection with each example system and method described herein, the reconstructed reference image may nevertheless be used for generating the difference frame in such systems and methods.

In this example, the difference frame 1224 is generated based on differences between values of elements of (at least part of) the target image 1204 and values of corresponding elements of the reconstructed reference image 1234. The reconstructed reference image 1234 is based on a combination of a processed reference image, namely the upsampled image 1216, and the residual frame 1220.

Other image processing measures (such as methods, systems, apparatuses, computer programs, bit streams, etc.) are also provided herein. A residual frame 1220 or a frame derived based on the residual frame 1220 is obtained. A difference frame 1224 or a frame derived based on the difference frame 1224 is obtained. A processed reference image, namely the upsampled image 1216 in this example, is obtained. The processed reference image 1216 is a processed version of the reference image 1202. A reconstructed reference image 1234 is generated based on a combination of the processed reference image 1216 and the residual frame 1220. A target image 1204 is generated based on a combination of the reconstructed reference image 1234 and the difference frame 1224. The reconstructed reference image 1234 and the target image 1204 are output. Such outputting may be for display.

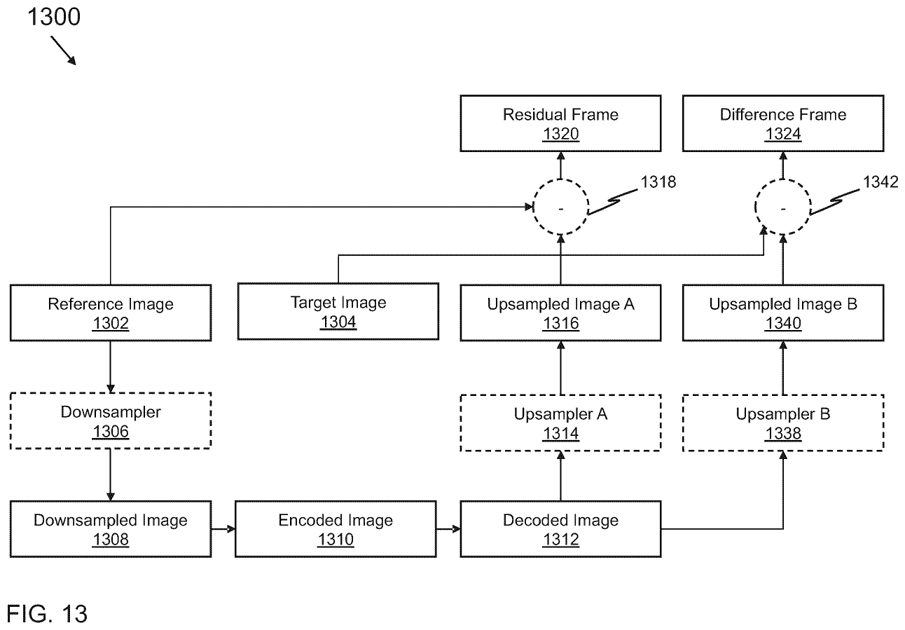

Referring to FIG. 13, there is shown another example image processing system 1300.

The example image processing system 1300 is similar to the example image processing system 1000 described above with reference to FIG. 10.

However, in this example, the upsampler 1314 is a first upsampler 1314, denoted “upsampler A” in FIG. 13, and the first upsampler 1314 generates a first upsampled image 1316, denoted “upsampled image A” in FIG. 13. Additionally, in the example image processing system 1300, there is a second upsampler 1338, denoted “upsampler B” in FIG. 13, and the second upsampler 1338 generates a second upsampled image 1340, denoted “upsampled image B” in FIG. 13.

In this example, the first upsampler 1314 is different from the second upsampler 1338. For example, the first and second upsamplers 1314, 1338 may be different types of upsampler, may be the same type of upsampler configured with different upsampler settings, or otherwise.

In this example, a comparator 1342 compares the target image 1304 and the second upsampled image 1340 and outputs the difference frame 1324.

In this example, the second upsampler 1338 may be selected and/or configured such that the second upsampled image 1340 is more similar than the first upsampled image 1316 to the target image 1304. In other words, second upsampler 1338 may be selected and/or configured such that the difference frame 1324 is smaller (for example in terms of data size) that the difference frame would be if the first upsampled image 1316 (and/or a residual-enhanced version of the first upsampled image 1316) were used to generate the difference frame in place of the second upsampled image 1340.

The second upsampler 1338 may be selected and/or configured based on one or more target characteristics. An example of one such target characteristic is minimising the size (for example data size) of the difference frame 1324.

As such, in this example, the decoded image 1312 is upsampled using an additional upsampler, namely the second upsampler 1338, to generate an additional processed reference image, namely the second upsampled image 1340. Additionally, in this example, the difference frame 1324 is generated based on differences between values of at least part of the target image 1304 and values of corresponding elements of the additional processed reference image, namely the second upsampled image 1340.

In this example, the same image derived from the reference image 1302, namely the decoded image 1312, is upsampled by different upsamplers, namely the first and second upsamplers 1314, 1338. In other examples, different images derived from the reference image 1302 may be upsampled by the same or different upsamplers. For example, different downsamplers may be used to generate different downsampled images, which may be upsampled by the same or different upsamplers, with one resulting image being used to generate the residual frame 1320 and the other resulting image being used to generate the difference frame 1324. In another example, the downsampled image 1308 may be processed in at least two different ways to generate different images, to be upsampled by the same or different upsamplers. For example, the way in which the downsampled image 1308 is encoded and/or decoded may be different for the different images, one version of the downsampled image 1308 may be transformed before being upsampled, and so on. Similar to that explained above in terms of the use of multiple upsamplers, in these other examples, the difference frame 1324 may be smaller (for example in terms of data size) than the difference frame would be if the first upsampled image 1316 (and/or a residual-enhanced version of the first upsampled image 1316) were used to generate the difference frame instead.

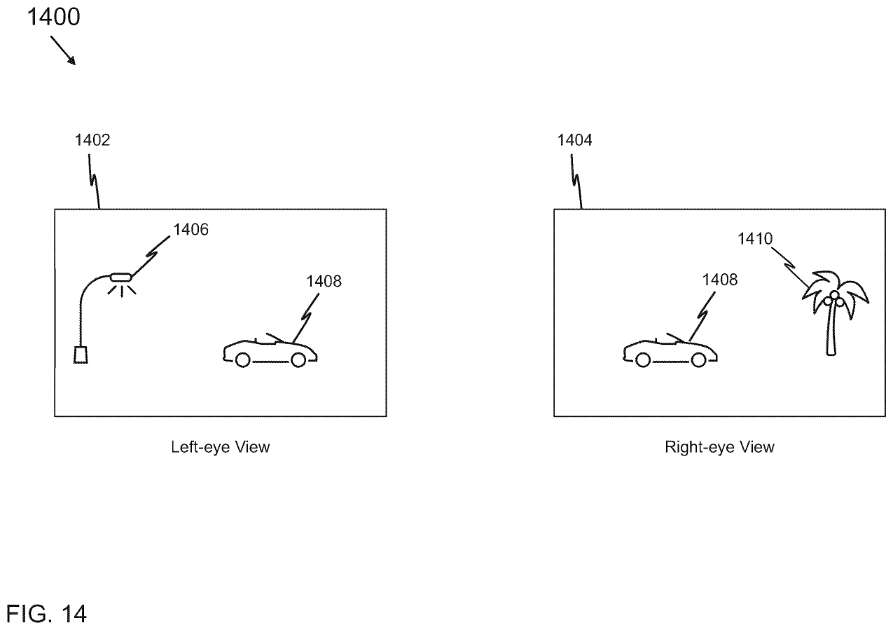

Referring to FIG. 14, there is shown an example of a representation 1400 of a scene. In this example, the representation 1400 comprises left-eye and right-eye views 1402, 1404.

Each of the left-eye and right-eye views 1402, 1404 represents a different view of a scene. In this example, the scene comprises first, second and third objects 1406, 1408, 1410. A scene can comprise different objects and/or a different number of objects in other examples.

In this example, the left-eye view 1402 includes the first and second objects 1406, 1408 and does not include the third object 1410. In this example, the right-eye view 1404 includes the second and third objects 1408, 1410 and does not include the first object 1406. As such, the first object 1406 is in the left-eye view 1402 only, the third object 1406 is in the right-eye view 1404 only, and the second object 1408 is in both the left-eye and right-eye views 1402, 1404. The second object 1408 may be referred to as a “shared” or “common” object in that the second object 1408 is shared in, and common to, both the left-eye and right-eye views 1402, 1404.

The first object 1406 may be at the very left of a field of view and, as such, may not be included in the right-eye view 1404. The third object 1410 may be at the very right of the field of view as and, as such, may not be included in the left-eye view 1402. The second object 1408 may be more central in the field of view and, as such, may be included in both the left-eye and right-eye views 1402, 1404.

The left-eye and right-eye views 1402, 1404 shown in FIG. 14 are exaggerated to facilitate understanding. In practice, the extent of differences between left-eye and right-eye views may be less drastic.

Additionally, although the second object 1408 is depicted identically in the left-eye and right-eye views 1402, 1404 shown in FIG. 14, the second object 1408 may, in practice, appear differently in the left-eye and right-eye views 1402, 1404 given the different perspectives associated with the left-eye and right-eye views 1402, 1404.

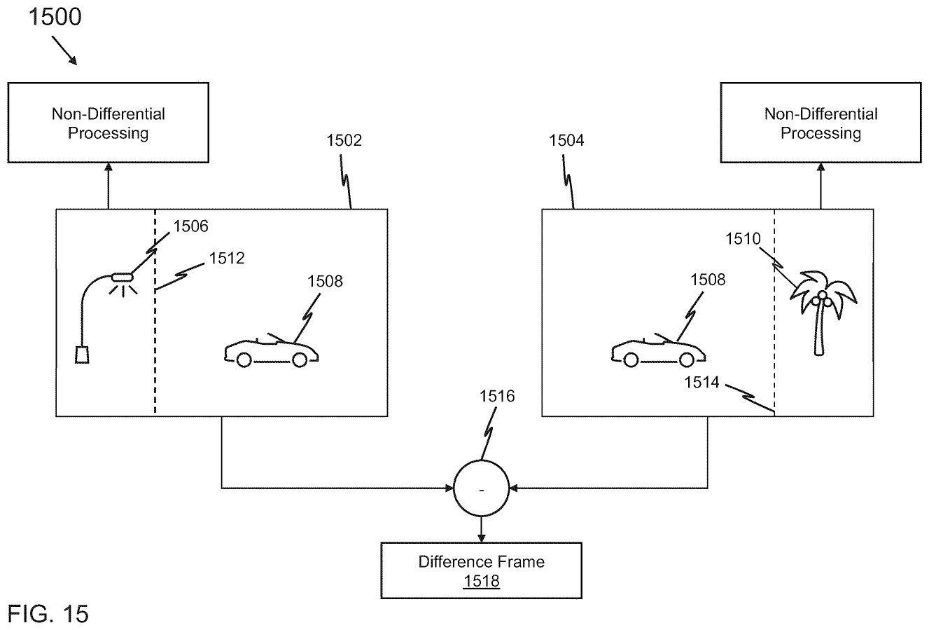

Referring to FIG. 15, there is shown an example of a representation 1500 of a scene and how the same may be processed, where the representation comprises left-eye and right-eye views 1502, 1504.

In this example, only parts of the left-eye and right-eye views 1502, 1504 are subject to the differential processing described above. In particular, in this example, other parts of the left-eye and right-eye views 1502, 1504 are not subject to the differential processing described above.

In more detail, in this example, one part of the left-eye view 1502, comprising the first object 1506 and to the left of a reference line 1512, is not subject to the differential processing described above. Similarly, in this example, one part of the right-eye view 1504, comprising the third object 1510 and to the right of a reference line 1514, is not subject to the differential processing described above. However, a part of the left-eye view 1502, comprising the second object 1508 and to the right of the reference line 1512, and a part of the right-eye view 1504, comprising the second object 1508 and to the left of the reference line 1514, are subject to the differential processing described above.

In particular, in this example, the parts of the left-eye and right-eye views 1502, 1504 that are subject to the differential processing are compared using a comparator 1516 to generate a difference frame 1518, such as described above.

However, in this example, the parts of the left-eye and right-eye views 1502, 1504 that are not subject to differential processing are not provided to the comparator 1516. Such parts may be processed in a different manner, for example as described above with reference to FIGS. 2A and 2B where differential processing is not used.

The reference lines 1512, 1514 are shown in FIG. 15 to aid understanding. They may be logical lines depicting a boundary between parts of the left-eye and right-eye views 1502, 1504 that are and are not subject to differential processing, rather than lines that are visible on the left-eye and/or right-eye views 1502, 1504.

The reference lines 1512, 1514 may be provided manually (by a human operator) or may be detected. Such detection may comprise analysis of the left-eye and right-eye views 1502, 1504 to identify common and/or different content. The reference lines 1512, 1514 may be produced during rendering. The reference lines 1512, 1514 may be found by identifying a vertical line and/or region of pixels of a given colour, for example black.

Although, in this example, each of the left-eye and right-eye views 1502, 1504 includes an object that is not included in the other of the left-eye and right-eye views 1502, 1504, in other examples, only one of the left-eye and right-eye views 1502, 1504 includes an object that is not included in the other of the left-eye and right-eye views 1502, 1504.

Although depicted as straight lines in FIG. 15, the reference lines 1512, 1514 may be a different type of reference marker in other examples. For example, the reference lines 1512, 1514 may be curved, corresponding, for example, to a fisheye lens.

As explained above, in examples described herein, differential processing is performed in respect of at least part of a reference image 1502 and at least part of a target image 1504. In this example, the at least part of the reference image 1502 is a portion of the reference image 1502. In other words, only part of the reference image 1502 is subject to differential processing. Additionally, in this example, the at least part of the target image 1504 is a portion of the target image 1504. In other words, only part of the target image 1504 is subject to differential processing.

In some examples, only part of one of the reference image 1502 and the target image 1502 is subject to differential processing and the whole of the other of the reference image 1502 and the target image 1504 is subject to differential processing.

As such, in this example, the reference image 1502 comprises at least one part that is processed in a different manner from how at least one other part of the reference image 1502 is processed. Additionally, in this example, the target image 1504 comprises at least one part that is processed in a different manner from how at least one other part of the target image 1504 is processed. In relation to both the reference image 1502 and the target image 1504, one part may be said to be subject to differential processing as described herein, and another part may be said to be subject to non-differential processing, where non-differential processing means processing other than the differential processing as described herein. In some examples, non-differential processing still includes calculating differences, for example to generate a residual frame. However, non-differential processing does not include the specific type of differential processing to generate a difference frame as described herein. As such, at least one part of the reference image 1502 may be processed non-differentially with respect to the target image 1504 and/or at least one part of the target image 1504 may be processed non-differentially with respect to the reference image 1502.

In this example, the at least one part of the reference image 1502 that is processed non-differentially comprises content that is not comprised in at least one other part of the target image 1504 that is processed non-differentially. In this example, such content comprises the first object 1506. Additionally, in this example, the at least one part of the target image 1504 that is processed non-differentially comprises content that is not comprised in at least one other part of the reference image 1502 that is processed non-differentially. In this example, such content comprises the third object 1510. As such, one or more objects that are not comprised in both the reference and target images 1502, 1504 are not subject to differential processing.

In this example, at least one part of the reference image 1502 that is processed differentially comprises content that is also comprised in at least one part of the target image 1504. In this example, such content comprises the second object 1508. In this example, the at least one part of the reference image 1502 and the at least one part of the target image 1504 that are subject to differential processing correspond to different views of the same content; in this example, the second object 1508. As such, in this example, such parts comprise shared content, namely content that is common to both parts.

In this example, the reference image 1502 represents one of a left-eye view of a scene and a right-eye view of the scene, and the target image 1504 represents the other of the left-eye view of the scene and the right-eye view of the scene.

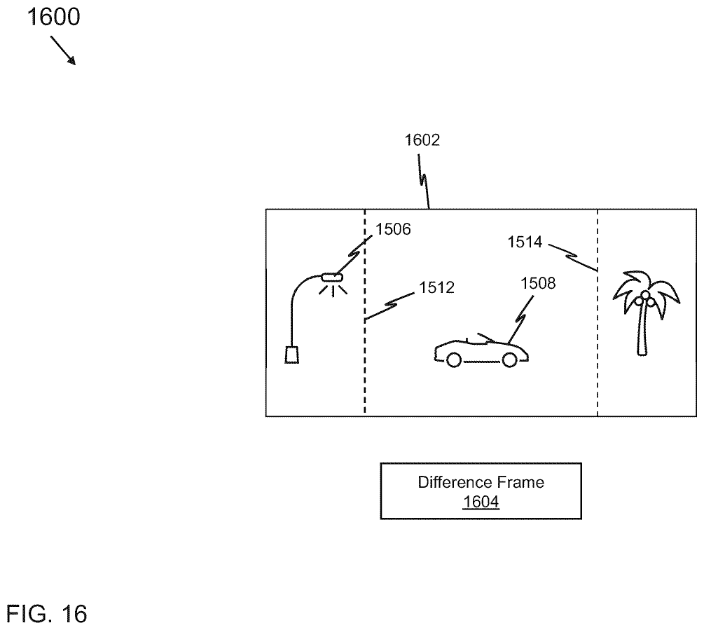

Referring to FIG. 16, there is shown an example of a representation 1600 of scene and a difference frame.

A concatenated image 1602 comprises the parts of the left-eye and right-eye views 1502, 1504 that are not subject to differential processing, and the part of the left-eye view 1502 that is subject to differential processing. The order of those parts may be different from the order shown in FIG. 16.

A difference frame 1604 represents differences between the part of the left-eye view 1502 that is subject to differential processing and the part of the right-eye view 1504 that is subject to differential processing.

The concatenated image 1602 and the difference frame 1604 may be output to a receiving device, potentially subject to processing prior to being output. The receiving device may obtain the left-eye view 1502 by extracting the parts of the left-eye view 1502 comprised in the concatenated image 1602. The receiving device may obtain the right-eye view 1504 by (i) combining the difference frame 1604 and the part of the left-eye view 1502 that is subject to differential processing and (ii) extracting the part of the right-eye view 1504 comprised in the concatenated image 1602, and (iii) concatenating the result of the combining with the extracted part of the right-eye view 1504.

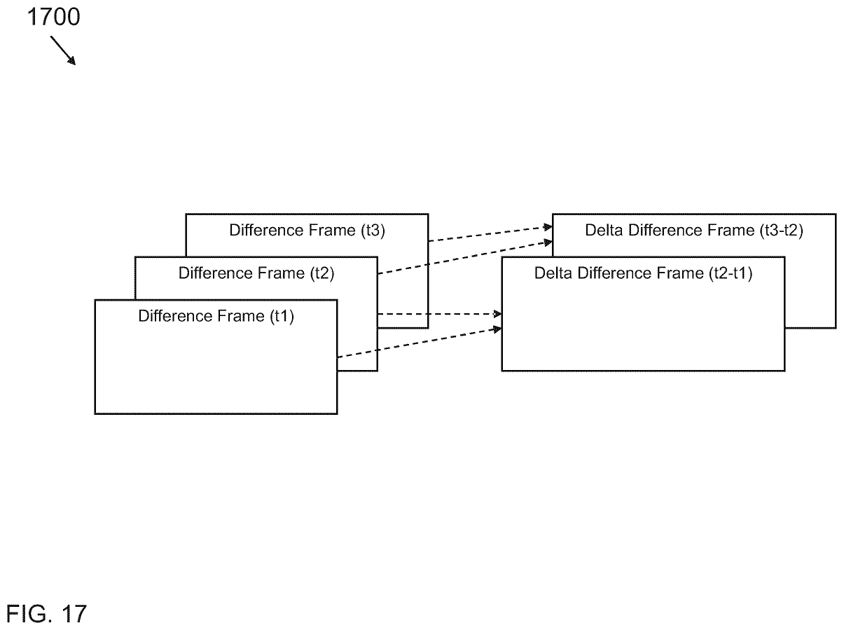

Referring to FIG. 17, there is shown an example of a representation 1700 of temporal processing in relation to difference frames.

In this example, instead of outputting a given difference frame, a delta difference frame is generated and is output. The delta difference frame may be processed (for example by transforming, quantising and/or encoding) prior to output.

The delta difference frame is generated as a difference between the given difference frame and another difference frame (e.g. a previous reference frame). Where the values of the difference frame do not change significantly between difference frames, it may be more efficient to output delta difference frames than difference frames. A receiving device may store a previous difference frame, and combine the previous difference frame with the delta difference frame to generate the current difference frame. A difference frame may be sent periodically to refresh the previous difference frame currently stored by the receiving device.

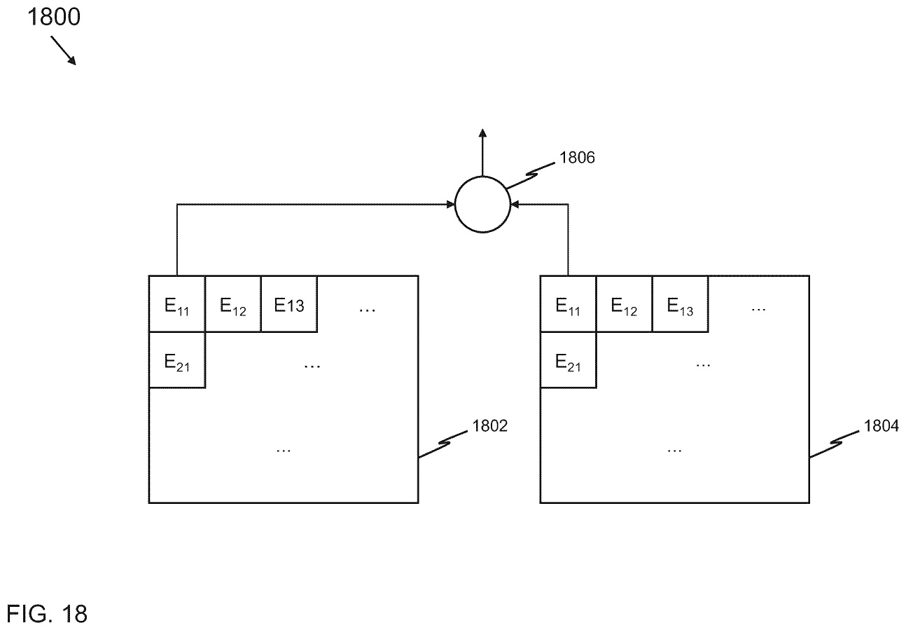

Referring to FIG. 18, there is shown an example of a representation 1800 of multiple images and how those images may be processed.

A first example image 1802 comprises multiple elements, with elements E₁₁, E₁₂, E₁₃, and E₂₁ being shown. Here, Eᵢⱼ represents an element in the iₜₕ row and jₜₕ column of the first example image 1802. Each element has an associated value, which may be denoted Vᵢⱼ, where Vᵢⱼ is the value of element Eᵢⱼ.

A second example image 1804 comprises multiple elements, with elements E₁₁, E₁₂, E₁₃, and E₂₁ being shown. Again, Eᵢⱼ represents an element in the iₜₕ row and jₜₕ column of the second example image 1804. Each element also has an associated value, Vᵢⱼ.

In this example, an element E_{ab} in the first example image 1802 corresponds to an element E_{cd} in the second example image 1804 when a=c and b=d.

In this example, an operator 1806 may perform an operation on the first and second example images 1802, 1804. Examples of such operations include, but are not limited to, addition and subtraction.

An output image or frame may be generate based on the output of the operator 1806. The output image or frame may comprise elements that corresponds to those of the first and second example images 1802, 1804. Each element of the output image or frame may have a value.

For example, where the operator 1806 comprises a comparator, the output image or frame may comprise an element E₁₁ which has a value V₁₁ which is the difference between the value V₁₁ of the element E₁₁ of the first example image 1802 and the value V₁₁ of the element E₁₁ of the second example image 1804, an element E₁₂ which has a value V₁₂ which is the difference between the value V₁₂ of the element E₁₂ of the first example image 1802 and the value V₁₂ of the element E₁₂ of the second example image 1804, and so on.

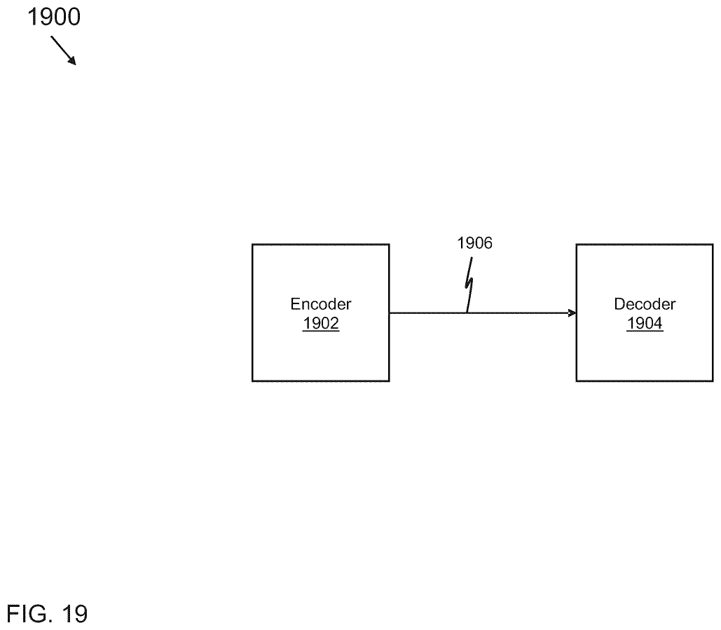

Referring to FIG. 19, there is shown an example of an image processing system 1900.

In this example, the system 1900 comprises an encoder 1902 and a decoder 1904. In this example, a bit stream 1906 is communicated between the encoder 1902 and the decoder 1904.

In this example, the bit stream 1906 comprises configuration data. The configuration data is indicative or one or more values of one or more image processing parameters used and/or to be used to perform any example method described herein. Examples of such more image processing parameters include, but are not limited to, encoder type, downsampler type, quantisation level, directional decomposition type, and so on.

In some examples, the bit stream 1906 comprises one or more residual frames and one or more difference frames as described herein. The bit stream 1906 may comprise one or more correction frames as described herein.

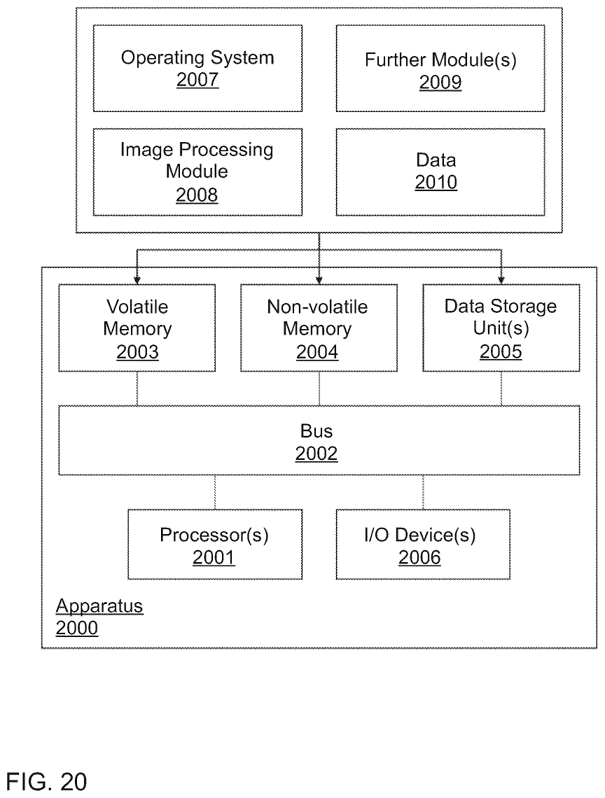

Referring to FIG. 20, there is shown a schematic block diagram of an example of an apparatus 2000.

In an example, the apparatus 2000 comprises an encoder. In another example, the apparatus 2000 comprises a decoder.

Examples of apparatus 2000 include, but are not limited to, a mobile computer, a personal computer system, a wireless device, base station, phone device, desktop computer, laptop, notebook, netbook computer, mainframe computer system, handheld computer, workstation, network computer, application server, storage device, a consumer electronics device such as a camera, camcorder, mobile device, video game console, handheld video game device, or in general any type of computing or electronic device.

In this example, the apparatus 2000 comprises one or more processors 2001 configured to process information and/or instructions. The one or more processors 2001 may comprise a central processing unit (CPU). The one or more processors 2001 are coupled with a bus 2002. Operations performed by the one or more processors 2001 may be carried out by hardware and/or software. The one or more processors 2001 may comprise multiple co-located processors or multiple disparately located processors.

In this example, the apparatus 2000 comprises computer-useable volatile memory 2003 configured to store information and/or instructions for the one or more processors 2001. The computer-useable volatile memory 2003 is coupled with the bus 2002. The computer-useable volatile memory 2003 may comprise random access memory (RAM).

In this example, the apparatus 2000 comprises computer-useable non-volatile memory 2004 configured to store information and/or instructions for the one or more processors 2001. The computer-useable non-volatile memory 2004 is coupled with the bus 2002. The computer-useable non-volatile memory 2004 may comprise read-only memory (ROM).

In this example, the apparatus 2000 comprises one or more data-storage units 2005 configured to store information and/or instructions. The one or more data-storage units 2005 are coupled with the bus 2002. The one or more data-storage units 2005 may for example comprise a magnetic or optical disk and disk drive or a solid-state drive (SSD).

In this example, the apparatus 2000 comprises one or more input/output (I/O) devices 2006 configured to communicate information to and/or from the one or more processors 2001. The one or more I/O devices 2006 are coupled with the bus 2002. The one or more I/O devices 2006 may comprise at least one network interface. The at least one network interface may enable the apparatus 2000 to communicate via one or more data communications networks. Examples of data communications networks include, but are not limited to, the Internet and a Local Area Network (LAN). The one or more I/O devices 2006 may enable a user to provide input to the apparatus 2000 via one or more input devices (not shown). The one or more input devices may include for example a remote control, one or more physical buttons etc. The one or more I/O devices 2006 may enable information to be provided to a user via one or more output devices (not shown). The one or more output devices may for example include a display screen.

Various other entities are depicted for the apparatus 2000. For example, when present, an operating system 2007, image processing module 2108, one or more further modules 2009, and data 2010 are shown as residing in one, or a combination, of the computer-usable volatile memory 2003, computer-usable non-volatile memory 2004 and the one or more data-storage units 2005. The data signal processing module 2008 may be implemented by way of computer program code stored in memory locations within the computer-usable non-volatile memory 2004, computer-readable storage media within the one or more data-storage units 2005 and/or other tangible computer-readable storage media. Examples of tangible computer-readable storage media include, but are not limited to, an optical medium (e.g., CD-ROM, DVD-ROM or Blu-ray), flash memory card, floppy or hard disk or any other medium capable of storing computer-readable instructions such as firmware or microcode in at least one ROM or RAM or Programmable ROM (PROM) chips or as an Application Specific Integrated Circuit (ASIC).

The apparatus 2000 may therefore comprise a data signal processing module 2008 which can be executed by the one or more processors 2001. The data signal processing module 2008 can be configured to include instructions to implement at least some of the operations described herein. During operation, the one or more processors 2001 launch, run, execute, interpret or otherwise perform the instructions in the signal processing module 2008.

Although at least some aspects of the examples described herein with reference to the drawings comprise computer processes performed in processing systems or processors, examples described herein also extend to computer programs, for example computer programs on or in a carrier, adapted for putting the examples into practice. The carrier may be any entity or device capable of carrying the program.

It will be appreciated that the apparatus 2000 may comprise more, fewer and/or different components from those depicted in FIG. 20.

The apparatus 2000 may be located in a single location or may be distributed in multiple locations. Such locations may be local or remote.

The techniques described herein may be implemented in software or hardware, or may be implemented using a combination of software and hardware. They may include configuring an apparatus to carry out and/or support any or all of techniques described herein.

Image processing measures (such as methods, systems, apparatuses, computer programs, bit streams, etc.) are provided herein. In accordance with some such measures, a reference image and a target image are obtained. The reference image represents a viewpoint of a scene at a given time. The target image represent a different viewpoint of the scene at the (same) given time. Due to the difference in viewpoints between the reference image and the target image, only a portion of the elements of the reference image have corresponding elements in the target image. For the portion of elements, a difference frame is generated as a difference between corresponding elements of the target image and the reference image. The difference frame or a frame derived based on the difference frame is output to be encoded.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

In examples described above, one of the reference and target images represents a left-eye view of a scene and the other of the reference and target images represents a right-eye view of the scene. However, the reference and target images may represent something else in other examples. For example, one of the reference and target images may represent content without subtitles and the other of the reference and target images may represent the same content with subtitles. In another examples, one of the reference and target images may comprise content in black and white, and the other of the reference and target images may represent the same content in colour. In a further example, the reference and target images may represent overlapping views of a scene obtained by different cameras in a security camera system. In yet another example, the reference and target images may correspond to multispectral images. In such an example, the reference and target images may correspond to the same view as each other but in respect of different frequencies. In such cases, the reference and target images may not be subject to pixel-shifting. However, one or both of the reference and target images may be pre-processed by transformation from one frequency to another frequency.

1-25. (canceled)

26. An image processing method, the method comprising:
obtaining a reference image and a target image;
processing at least part of the reference image to generate a processed reference image;
generating a residual frame, the residual frame being indicative of differences between values of elements of the at least part of the reference image and values of corresponding elements of the processed reference image;
generating a difference frame as a difference between:
values of elements of at least part of the target image or of an image derived based on at least part of the target image; and
values of elements of the at least part of the reference image or of an image derived based on the at least part of the reference image; and
outputting, to be encoded:
the residual frame or a frame derived based on the residual frame; and
the difference frame or a frame derived based on the difference frame.

27. The method according to claim 26, wherein the processing of the at least part of the reference image comprises:
outputting, to be encoded to generate an encoded image, the at least part of the reference image or the image derived based on the at least part of the reference image; and
obtaining a decoded image from a decoder, the decoded image being a decoded version of the encoded image.

28. The method according to claim 26, wherein the processing of the at least part of the reference image comprises:
downsampling the at least part of the reference image using a downsampler to generate a downsampled image;
outputting, to be encoded to generate an encoded image, the downsampled image;
obtaining a decoded image from a decoder, the decoded image being a decoded version of the encoded image; and
upsampling the decoded image or an image based on the decoded image using an upsampler to generate the processed reference image.

29. The method according to claim 28, further comprising upsampling the decoded image using an additional upsampler to generate an additional processed reference image, wherein the difference frame is generated based on differences between values of elements of the at least part of the target image and values of corresponding elements of the additional processed reference image.

30. The method according to claim 26, wherein the difference frame is generated based on differences between values of elements of the at least part of the target image and values of corresponding elements of the processed reference image.

31. The method according to claim 26, wherein the difference frame is generated based on differences between values of elements of the at least part of the target image and values of corresponding elements of a reconstructed reference image, the reconstructed reference image being based on a combination of the processed reference image and the residual frame.

32. The method according to claim 26, wherein the at least part of the reference image is a portion of the reference image and/or wherein the at least part of the target image is a portion of the target image.

33. The method according to claim 32, wherein:
the reference image comprises at least one other part that is processed in a different manner from how said at least part of the reference image is processed; and/or
the target image comprises at least one other part that is processed in a different manner from how said at least part of the target image is processed.

34. The method according to claim 33, wherein:
said at least one other part of the reference image comprises content that is not comprised in said at least one other part of the target image; and/or
said at least one other part of the target image comprises content that is not comprised in said at least one other part of the reference image.

35. The method according to claim 26, wherein the reference image represents one of a left-eye view of a scene and a right-eye view of the scene and the target image represents the other of the left-eye view of the scene and the right-eye view of the scene.

36. The method according to claim 26, wherein the encoder comprises a Low Complexity Enhancement Video Coding, LCEVC, encoder and/or the decoder comprises an LCEVC decoder.

37. The method according to claim 26, wherein the reference image and/or the target image is generated as a result of transcoding or rendering point cloud or mesh data.

38. A bit stream comprising configuration data, the configuration data being indicative or one or more values of one or more image processing parameters used and/or to be used to perform the method according to claim 26.

39. An apparatus comprising:
a processor;
a non-transitory computer storage device having stored thereon computer executable instructions that, when executed by the processor, cause the apparatus to perform the following:
obtain a reference image and a target image;
process at least part of the reference image to generate a processed reference image;
generate a residual frame, the residual frame being indicative of differences between values of elements of the at least part of the reference image and values of corresponding elements of the processed reference image;
generate a difference frame as a difference between:
values of elements of at least part of the target image or of an image derived based on at least part of the target image; and
values of elements of the at least part of the reference image or of an image derived based on the at least part of the reference image; and
outputting, to be encoded:
the residual frame or a frame derived based on the residual frame; and
the difference frame or a frame derived based on the difference frame.

40. A non-transitory computer storage device having stored thereon computer executable instructions that, when executed by a processor, cause the processor to perform the following:
obtain a reference image and a target image;
process at least part of the reference image to generate a processed reference image;
generate a residual frame, the residual frame being indicative of differences between values of elements of the at least part of the reference image and values of corresponding elements of the processed reference image;
generate a difference frame as a difference between:
values of elements of at least part of the target image or of an image derived based on at least part of the target image; and
values of elements of the at least part of the reference image or of an image derived based on the at least part of the reference image; and
outputting, to be encoded:
the residual frame or a frame derived based on the residual frame; and
the difference frame or a frame derived based on the difference frame.
